(19) United States
(12) Patent Application Publication
(10) Pub. No.: US 2026/0350858 A1
(43) Pub. Date: Nov. 5, 2026

(54) APPARATUS FOR AND METHOD OF MEASURING A TRAJECTORY OF AN OBJECT

(71) Applicant: PitchLab AI, Inc., Sharon, MA (US)

(72) Inventors: Jake Fishman, Sharon, MA (US); Brian Martin, Sudbury, MA (US)

(73) Assignee: PitchLab AI, Inc., Sharon, MA (US)

(21) Appl. No.: 19/667,262

(22) Filed: May 4, 2026

Related U.S. Application Data
(60) Provisional application No. 63/799,505, filed on May 3, 2025.

(51) Int. Cl. G06T 11/00; G06F 3/16; G06T 7/246; G06T 7/73; G06V 10/62; G06V 10/82; G06V 20/40

(52) U.S. Cl. CPC G06T 11/00; G06F 3/16; G06T 7/246; G06T 7/73; G06V 10/62; G06V 10/82; G06V 20/42; G06T 2200/24; G06T 2207/20081; G06T 2207/20084; G06T 2207/30196; G06T 2207/30224; G06T 2207/30241

(57) ABSTRACT

An apparatus and method for measuring a trajectory of an object. The apparatus includes at least an imaging device configured to capture a plurality of frames of an object, at least a computing device, wherein the computing device comprises a memory and at least a processor communicatively connected to the memory, wherein the memory contains instructions configuring the at least a processor to receive the plurality of frames, store the plurality of frames in a memory buffer, analyze the plurality of frames, generate an output comprising trajectory data of the trajectory, and transmit the output to a user.

### CROSS-REFERENCE TO RELATED APPLICATIONS

This application claims the benefit of priority of U.S. Provisional Patent Application Ser. No. 63/799,505, filed on May 3, 2025, and titled “SYSTEM AND METHOD FOR MEASURING AND RECORDING AERODYNAMIC PROJECTILE TRAJECTORIES,” which is incorporated by reference herein in its entirety.

### FIELD OF THE INVENTION

The present invention generally relates to the field of computer vision and machine learning. In particular, the present invention is directed to an apparatus for and a method of measuring a trajectory of an object.

### BACKGROUND

Existing motion detection and tracking methods typically rely on multiple sensors to capture precise data on an object's position and motion. These solutions most often use a combination of multiple doppler radar antennas, multiple high speed cameras, or a combination of radar and camera since a single sensor has not been shown to accurately measure an object's position and motion in all directions simultaneously. For instance, a Doppler radar excels at measuring motion parallel to the direction of the radar signal but cannot accurately measure motion perpendicular to the direction of the radar signal. To accurately measure this perpendicular motion, additional sensors are traditionally used. Systems with multiple sensors are expensive, complicated, and require extensive calibration.

Additionally, real-time motion analysis combined with video recording of the motion, presents challenges on resource constrained hardware such as cell phones and low power embedded processors. When frame rate is high, the system will draw more power causing the hardware to overheat and quickly drain batteries. The desired frame rate may also exceed the capabilities of the processor causing frame skipping resulting in inaccurate or completely missed measurements.

Finally, to date, there have been no demonstrations of a commercial solution for accurate 3D aerodynamic trajectory measurements from a single monocular camera. There are systems which use a single camera to measure velocity in two dimensions, but not three. There are systems which model the expected trajectory of a launched object, but they do not measure it. There are systems which can estimate velocity in 3D but are not able to measure minor accelerations applied to the object. With the deficiencies of existing systems, there is a clear need for an accurate, efficient, and cost-effective method for precisely quantifying 3D motion of a launched object.

### SUMMARY OF THE DISCLOSURE

In an aspect, an apparatus for measuring a trajectory of an object includes at least an imaging device configured to capture a plurality of frames of an object at a first frame rate and at least a computing device, wherein the at least a computing device comprises a memory and at least a processor communicatively connected to the memory, wherein the memory contains instructions configuring the at least a processor to receive, from the at least an imaging device, the plurality of frames, wherein the plurality of frames comprises image data representing the object, store the plurality of frames in a memory buffer, analyze the plurality of frames by detecting, using a machine-learning model, the object in at least one frame of the plurality of frames, wherein detection is performed at a second frame rate lower than or equal to the first frame rate, selecting a subset of the stored plurality of frames as a function of the detection of the at least one frame, wherein the subset of the stored plurality of frames comprises a windowing of frames, determining one or more distances between the at least an imaging device and the object by computing an appearance of the object based on the windowing of frames, determining a position of the object within the windowing of frames based on the appearance of the object, and determining a trajectory of the object as a function of the one or more distances and the position of the object using a physical model of projectile motion, generate an output comprising trajectory data of the trajectory, and transmit the output to a user.

In another aspect, a method of measuring a trajectory of an object includes capturing, using capturing, using at least an imaging device communicatively connected to at least a computing device comprising at least a processor and a memory, a plurality of frames of an object at a first frame rate, receiving, from the at least an imaging device, the plurality of frames, wherein the plurality of frames comprises image data representing the object, compressing, using a compression process, the plurality of frames, storing, using the at least a processor, the compressed plurality of frames in a memory buffer, analyzing, using the at least a processor, the compressed plurality of frames by detecting, using a machine-learning model, the object in at least one frame of the compressed plurality of frames, wherein detection is performed at a second frame rate lower than or equal to the first frame rate, selecting a subset of the compressed plurality of frames as a function of the detection of the at least one frame, wherein the subset of the compressed plurality of frames comprises a windowing of frames, determining one or more distances between the at least an imaging device and the object by computing an appearance of the object based on the windowing of frames, determining a position of the object within the windowing of frames based on the appearance of the object, and determining a trajectory of the object as a function of the one or more distances and the position of the object using a physical model of projectile motion, generating, using the at least a processor, an output comprising trajectory data of the trajectory, and transmitting, using the at least a processor, the output to a user.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic of an apparatus for measuring and recording aerodynamic projectile trajectories;

FIG. 2 is a schematic diagram illustrating an orientation of a camera with respect to a launched object showing a real-world coordinate system with respect to the camera;

FIG. 3 is an example image frame comprising pixel data illustrating a launched object in pixel coordinates associated with the frame;

FIG. 4 is a flowchart illustrating a method for measuring a three-dimensional aerodynamic projectile trajectory using a monocular camera;

FIG. 5 is a flowchart illustrating a method of performing object detection;

FIG. 6 is a flowchart illustrating a method of performing object tracking;

FIG. 7 is a flowchart illustrating a method of determining a trajectory of an object;

FIG. 8 is a flowchart illustrating a method of processing trajectory information within an apparatus;

FIG. 9 is an example user interface illustrating information conveyed to a user based on the trajectory of the object;

FIG. 10 is a block diagram of an exemplary embodiment of an apparatus for measuring a trajectory of an object;

FIG. 11 is a block diagram of an exemplary machine-learning module;

FIG. 12 is a diagram of an exemplary embodiment of a neural network;

FIG. 13 is a diagram of an exemplary embodiment of a node of a neural network;

FIG. 14 is a block diagram of an exemplary embodiment of a method of measuring a trajectory of an object; and

FIG. 15 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

The present embodiments are directed to an apparatus and method for measuring a trajectory of an object comprising a monocular camera, memory, and a processor; the camera used to collect a multiple of frames of a launched object which are stored in memory and analyzed by the processor to determine the three dimensional (3D) aerodynamic projectile trajectory of the object. Information related to the trajectory is then conveyed to the user of the system. In an embodiment, the monocular camera is a two-dimensional imager collecting frames of video and the processor computing the 3D aerodynamic projectile trajectory may contain a CPU, GPU, and/or a NPU. In an embodiment, intrinsic parameters of the monocular camera are determined prior to this method while the extrinsic parameters may be unknown, partially known, estimated, or determined from a calibration process. In an embodiment, video frames are collected from either live capture from the camera or from pre-recorded video capture from the camera. In an embodiment, the collected frames are stored as video for post event processing, analysis, and viewing. In an embodiment, the method for converting pixel data in the video frames to 3D aerodynamic projectile trajectory employs a ring buffer of analyzed and skipped video frames to allow post event processing. In an embodiment, the processor predicts the physical distance between the object and the camera using only the appearance of the object defined by the pixel data in the video frames using neural networks which have been trained to predict the distance based on the object appearance alone. In an embodiment, the memory is used to store the weights from trained neural networks which predict in whole or in part the physical location of specific objects relative to the monocular camera. In an embodiment, the relative physical locations of the object in three or more frames collected at different times are fit to the equations of motion for an aerodynamic projectile trajectory to improve the signal to noise of the trajectory measurement. In an embodiment, the relative physical locations of the object are conveyed to a user of the system with either visual, haptic, or auditory signals. This conveying of information could be in real-time or at a later time. This conveying of information could be on the same device as used for the trajectory measurement or can be provided from another connected device. In an embodiment, the object is a sports ball.

At a high level, aspects of the present disclosure are directed to systems, apparatuses and methods for measuring a trajectory of an object. The apparatus includes at least a computing device comprised of a processor and a memory communicatively connected to the processor. The memory instructs the processor to receive, from the at least an imaging device, a plurality of frames, wherein the plurality of frames comprise image data representing the object. The processor determines, using a machine-learning model, one or more distances between the at least an imaging device and the object by computing an appearance of the object. The processor determines a position of the object within the plurality of frames based on the appearance of the object. The processor determines a trajectory of the object as a function of the one or more distances and the position of the object using a physical model of projectile motion. The processor validates the trajectory based on predicted projectile behavior. The processor generates an output comprising trajectory data of the trajectory. The processor transmits the output to a user.

Exemplary embodiments illustrating aspects of the present disclosure are described below in the context of several specific examples.

The present invention will now be described in detail. The description focuses on certain embodiments of the invention for clarity. Some descriptions of common concepts to those skilled in the art may not be provided. The system description provided here is not meant to cover all possible embodiments.

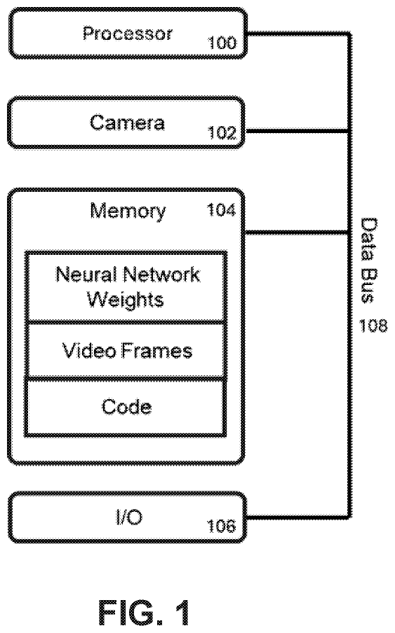

One or more embodiments include or involve use of a single monocular camera, such as that found on a cell phone, being used to simultaneously record video and measure the aerodynamic projectile trajectory (APT) of an object such as a sports ball (baseball, golf ball, soccer ball, etc.). This apparatus is represented by the schematic in FIG. 1 with the camera 102 being connected to a processor 100 and memory 104 via a data bus 108. Other system components such as storage, network interface, user interface, etc. could be connected as part of general I/O 106 functionality of the device. These connected I/O devices can dictate the type of feedback the system may provide to the user and when and where it can be provided.

The camera 102 should be of sufficiently high pixel resolution to capture the flight of the object. This is typically referred to as HD, UHD, or 4K. Though the methods described here are not limited by pixel resolution, higher pixel resolution can provide more precision to the trajectory measurements. The camera 102 should also be of sufficiently high frame rate to provide enough samples to measure the flight of the object. This can be as low as 30 frames per second (fps) but is often higher. It is not uncommon to need 60 fps, 120 fps, 240 fps, or more depending on the maximum speed of the object being measured. Correspondingly, the camera exposure time must be sufficiently short to stop motion in the video frame. Other aspects of the camera's 102 configuration should be configured as to not hinder the quality of the captured video. These include sensor noise (gain), optics, compression, internal camera processing, and exposure.

The processor 100 could be made up of a CPU, a GPU, an NPU, or any other processing unit. The processor will execute the instructions for the apparatus and method, including processing video, neural networks, numerical analysis, decision logic, and potentially graphical and auditory signal generation.

This invention uses the term aerodynamic projectile trajectory or APT for short. The APT is the flight path (trajectory) of a launched object that does not power itself and is not propelled by any external actor after the launch point. It differs from traditional projectile motion in that traditional projectile motion is only concerned with gravity acting on the launched object. It differs from ballistic motion, which does account for air drag, in that ballistic motion does not account for aerodynamic lift. Therefore, the term aerodynamic projectile trajectory APT clarifies that this is a launched object with lift forces included in the motion. The description and claims may sometimes use the term ‘motion’ or ‘trajectory’ or ‘APT’ for brevity, with the understanding that this is referring to ‘aerodynamic projectile trajectory’.

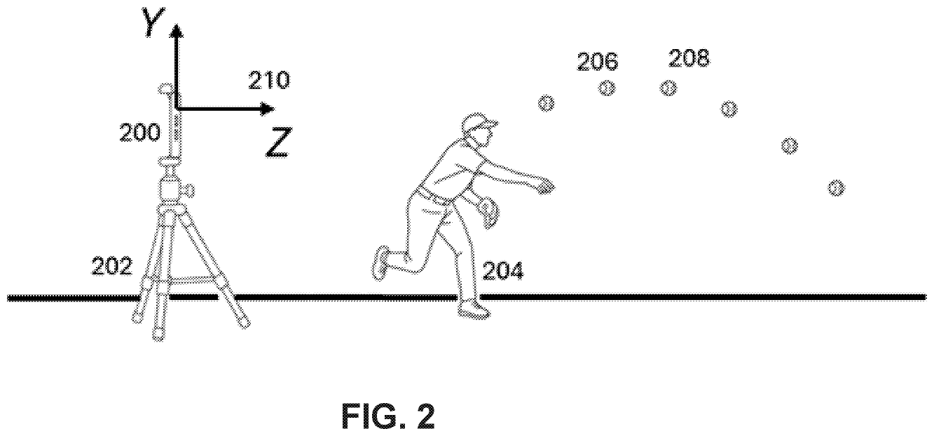

Some embodiments have a recommended camera view configuration as shown in FIG. 2. The camera 200 is typically pointed parallel to the primary direction of flight of the object-either towards or away from the camera. Closer placement of the camera to the object in flight results in the object being larger in the view which will result in more accurate analysis of the object's appearance. The object in FIG. 2 is a baseball 206 and is launched into flight by a human 204. The camera 200 is shown here being held by a tripod 202 though there is no strict requirement for a tripod.

One notable aspect of this apparatus which differs from typical approaches is that the camera setup does not require calibration to the specific environment. That is, there are no extrinsic parameters required for the conversion from pixel data to real-world coordinates. This is because this approach makes all measurements relative to the camera's position and it's coordinate system, shown in FIG. 2 as 210. This description will use the convention of calling the direction aligned with the camera's view axis as the positive Z direction. The directions perpendicular to this direction are the X and Y direction, which can be oriented arbitrarily. For this embodiment, we assume the Y direction is opposite the direction of the earth's gravity. This can be enforced when the camera is setup by asking the user to align the horizon with a horizontal line drawn on the screen of the display. Use of an accelerometer could also be used to provide user feedback during camera setup. Some may also instead store the measured accelerometer information during setup so that it could be used afterwards to put the APT into a different coordinate system than that defined by the camera orientation.

The launched baseball in FIG. 2 is shown here at multiple points in times. Baseball 206 is shown from an earlier time than baseball 208. The video captured by camera 200 will capture multiple frames of video and these frames will have captured the baseball at different points in time. These different points in time do not need to be evenly spaced but should encompass the complete flight of the object from launch until landing or until the observation is no longer of interest. These time measurements are synonymous with the timestamp of the video frame.

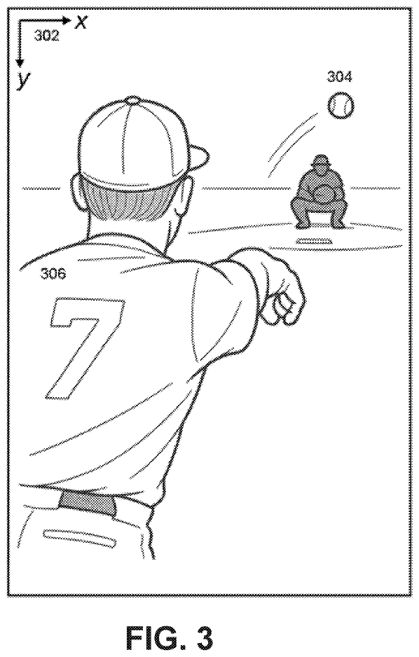

An example of what the camera 200 in FIG. 2 is capturing is depicted in FIG. 3. Here the baseball 304 is seen after it was launched by a human 306. It is often ideal to include other objects in the field of view besides the projectile to add context and to allow for more useful user feedback. The single image at a specific point in time is referred to as a frame of video. This frame is composed of discrete pixels representing the color and intensity at each position in the video frame. The image coordinates 302 in the frame are represented by lowercase x and y to denote the horizontal and vertical positions of pixels respectively. With this coordinate system defined, the location of the baseball 304 can be provided as x-y values in the camera coordinates. One of the novelties of this invention is how it translates the pixel information in camera coordinates to real world XYZ trajectories.

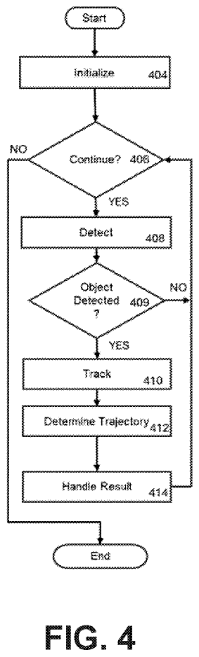

In FIG. 4 the high-level workflow is provided for some embodiments. The main steps are initialization 404, detection 408, tracking 410, determining APT 412, and handling results 414. These steps are handled repeatedly, in sequence, until the user of the apparatus decides to end the process at conditional step 406.

In the initialization 404 step, some embodiments load all processor instructions and required data into memory for processing. These items are loaded from one of the I/O systems 106 connected to the memory such as a mass storage device or a network server. During this initialization process the camera starts or in other embodiments a pre-captured video is loaded to provide a source of video frames. The weights used to initialize neural networks are loaded. Other intrinsic calibration parameters specific to the camera and object of interest (for instance a baseball) are loaded.

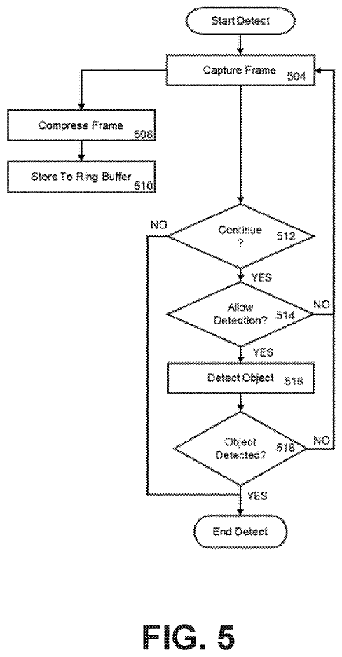

The next step is to begin object detection 406. The details of this step are broken out in FIG. 5. During the detection phase, the goal is to identify the desired object in flight in at least one video frame.

In the detection step, first a frame is collected 504 which has been captured from a camera with known intrinsic calibration parameters which could include the focal length and sensor size. The captured frame can optionally be compressed 508. This may be required if several frames are captured and system memory is unable to hold all captured frames in their uncompressed format. After the frame is collected, it is stored in system memory, here in a ring buffer 510 which acts as short term memory for the projectile flight. Note in FIG. 5 that 508 and 510 are branched since these steps need not be sequentially between 504 and 512. They may run asynchronously and concurrently with other processing steps since the subsequent processing uses the original (uncompressed) frame. The ring buffer used for storage should be large enough to store all video frames required to measure the full flight of the object. For many sports use cases, this would be on the order of 1 second to a few seconds of video. When storing to a ring buffer, old memory is overwritten with the most recent frames such that the latest video frames are always available. If processing is to continue 512, a decision must be made 514 if the detection process should occur or if detection will be skipped for the current video frame. It may likely be the case that frames are captured faster than they can be processed by the processor. In these cases, frames are skipped as to not overload the processor but may still be retained in the ring buffer. For many sports applications a frame rate as low as 10 fps may be sufficient to detect an object in flight since we only are looking for a single frame containing the object. Using the ring buffer will however allow extremely high frame rates)~1000 fps to be captured for analysis if needed. When detection is allowed, an attempt is made to detect 516 the object in the current video frame.

Object detection can be accomplished with a convolutional neural network (CNN) that has been specifically trained to detect the object of interest, or related objects, in various environments and conditions. The most common type of CNN detectors are based on YOLO (you only look once) and SSD (single shot detector) architectures. Both are very accurate and can be computationally inexpensive allowing real-time detection on mobile devices. In our example scenario we would have a CNN detector trained to detect baseballs, however there is no requirement that the object be only a baseball. The detectors in this invention can be applied to any object as long as the proper training is performed on the CNN to detect the object. It is noted that related objects separate from the primary object of interest may be detected and could be used to aid in classification steps in the triggering of the tracking or post-processing of the flight trajectory.

Some typical methods can use edge detection, Haar cascade filters, and other legacy approaches. Such approaches typically do not have the robustness required for object detection in uncontrolled situations where the environment and lighting can be challenging.

The outputs of the detection step 516 are typically the pixel coordinates of the detected objects and a confidence measure where higher confidence represents a higher likelihood the object was detected accurately. This confidence, and additional information such as the position, orientation, and size of the object can be used to estimate if the object is appropriate for beginning the tracking. If the confidence is low, or the position of the object suggests it may be a false positive detection, the decision in 518 may be to discard the result and capture another frame. If the object is determined to be successfully collected, the detection step will end and returning to FIG. 4 we use the decision 409 to allow progression to the tracking step 410.

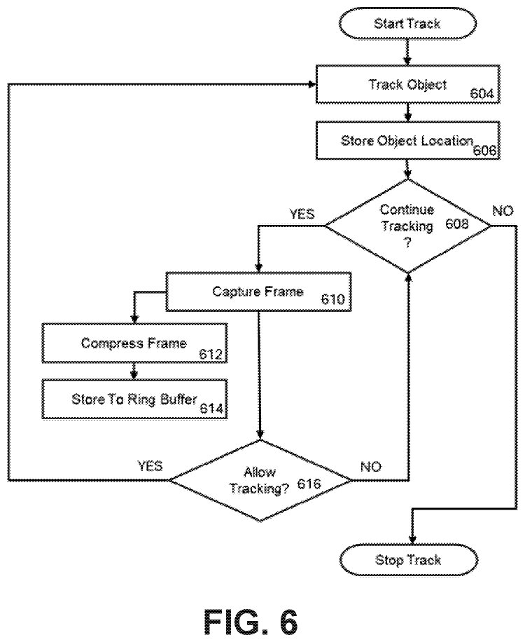

The object tracking process shown in FIG. 6 is similar in spirit to the object detection process. However, in this process the entire frame is not surveyed for the object. Instead, the focus is in a region of interest determined by previously detected objects. Within this restricted region, a different CNN that specializes in detecting an object in a smaller region of interest and with expectations on the object's size and position can be used. This allows for a more efficient use of the processor and also reduces false positives which may occur with the aforementioned CNN detector (from FIG. 5).

In FIG. 6 the tracking starts in the track object step 604. Object tracking is a mature field where there are several well-established techniques such as the use of Kalman filters to improve tracking by including recent object positions which are used to update an internal model that helps to guide future tracking positions. The tracking step 604 can be considered similar to these well-known approaches.

One novelty in some embodiments of the invention is that the object detection is performed by a CNN which has been trained to not only return the confidence and the x, y coordinates of the object being tracked, but it also returns a value representing the distance of the object from the camera. That is, a value that can be used to directly obtain the world coordinate Z value of the object. From optics we know Z is inversely proportional to the size of the object as viewed through a lens. Despite this relationship, accurately measuring the actual size of the object in pixels is made difficult by the changing appearance of the object under different environmental conditions and under different camera configurations. This ability to retrieve the object's distance from the camera, or inversely it's real-world size, using a CNN is one of the major innovations in some embodiments of the invention compared to typical approaches.

To give an example, in typical approaches, the conversion from 2D pixel coordinate to 3D world coordinates is often glazed over citing the use of the inverse relationship between Z and the object's size. In practice the object's size is difficult to measure when there is lighting bloom, when the background provides high contrast, when internal camera processing changes the image, and when there is change in focus as the object enters and leaves the camera's focal plane. To complicate matters, for objects that have complex shapes, the idea of a single definition for the object's size is unrealistic. For instance, the size of an American football is not the same in each dimension. This makes the conversion of its viewed dimensions to distance measure difficult since the orientation of the football would have to be taken into account. The CNN based tracking we describe, in accordance with some embodiments, would instead output a distance or a single size metric without any additional information about the orientation of the object or the state of the environment. These complicating factors have been accounted for by training the network to be robust to orientation, illumination, focus, etc., and to return a value invariant to those factors.

After the first frame is tracked, the tracked information including x, y, Z and confidence is stored 606 and used to update any predictions for the location of the next tracked frame.

At this point, the tracking output is analyzed to determine if tracking should continue 608. Tracking can stop after a set timeout which would be the maximum time the object is expected to be in flight, or can stop tracking if the tracking confidence is too low or has been too low for a number of frames. Tracking can also stop if the position of the object leaves the area of interest.

When tracking continues, video is collected 610, optionally compressed 612, and stored to memory 614 similar to the detection process from FIG. 5. It is again noted that 612 and 614 need to be sequentially between 610 and 614 and may run asynchronously with other parts of tracking. Also similar to detection, a decision 616 is made if tracking is allowed on the current frame. As with detection, tracking may skip frames if frame rate is too high compared to available processing power.

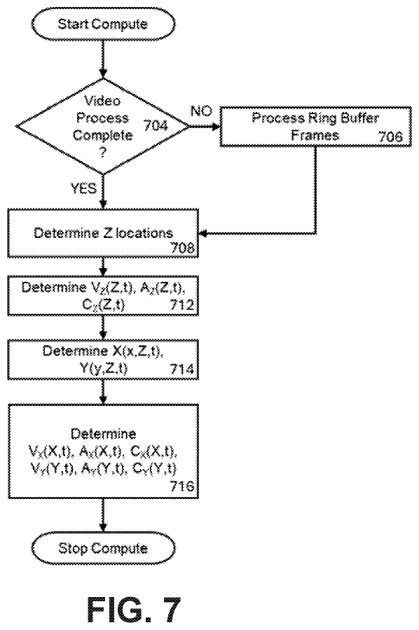

When tracking is complete as described above in 608 FIG. 1 shows that the next step is to determine the APT 412 of the object. The details of this determination of APT are presented in FIG. 7.

Immediately after tracking a decision 704 is made to determine if sufficient information is available from the tracking step to allow accurate measurement of the object's APT. Often, since the detection may be running at a lower frame rate than the frame storage, the initial conditions of the launch of the object may have been missed. Other times the frame rate during tracking may simply have been too low and additional samples may be required for accurate processing. In these cases the video processing is not complete and additional processing of frames 706 is performed. This additional processing is equivalent to the tracking process depicted in FIG. 6 but includes additional frames that were not previously processed. In other embodiments the tracking process can process the same frames using alternate algorithmic approaches which are impractical in real-time.

Video processing is complete when a sufficient number of frames are processed. Minimally, three frames are required since we desire to measure second order terms in the equations of motion (accelerations or lift). In practice, more frames with accurate tracking information will tend to produce more accurate measurements of the APT. Each frame's individual contribution to the APT has some error associated with it. Errors tend to fluctuate about the actual value. Similar to the law of large numbers, having more samples helps to average out the noise and bring the measured value closer to the actual value.

The ability to go back in time via the video in the ring buffer and post process the event is another of the innovations in this embodiment. It affords the ability to process initially missed frames and to build a larger number of samples than would have been possible if only processing in real-time. Since the object's flight is finished, more time can be taken to process all frames captured. Some examples of the extra processing could include using a more accurate detection approach or could include human pose estimation to better understand a human subject's interaction with the launched object.

The computation required to extract the 3D APT starts after video processing is complete. First the Z locations for all frames are determined. These may come directly from the tracking CNN or may be derived from the object size in pixel coordinates with intrinsic camera calibration information and the knowledge of the physical size of the object in the real-world coordinates.

Determining the velocity and acceleration of the object in the Z direction 712 follows. Assuming acceleration is nearly constant, the Z data should follow Newton's equation of motion: Z(t)=Z₀+V_{Z0}·t+½·A_{Z0}·t². Note that air drag, which is prominent in this direction of flight, depends on velocity. However, for many use cases such as that of a baseball, a constant acceleration term is a sufficient approximation. Even professional sports such as Major League Baseball have adopted this approximation in their Statcast nine parameter fit data. Here Z(t) is the Z position as a function of time t. Z₀ is the position of the object at t=0 which we adopt as the time of launch. V_{Z0} is the launch velocity and A_{Z0} is the constant acceleration in the Z direction. Using the measured Z values with known capture time t, the values of V_{Z0} and A_{Z0} can be determined with a number of standard curve fitting or optimization methods such as linear least squares fit. At this point the motion in the Z direction has been determined. Furthermore, a confidence value or residual can be calculated to assess the strength of the fitting.

The next step is to determine the X and Y locations of the object in real world coordinates. To this point, there has been no discussion of these values, yet they are perhaps the most interesting aspects of the flight as they show the effects of spin on the projectile. For a baseball this would represent the different type of pitch (i.e. curve ball, fast ball, etc.) while in golf this would show the shot type (i.e. fade, draw). The movement in these directions is often subtle compared to that in the primary launch direction. Measuring this movement precisely requires an innovation to combat the noise (error). Again, the law of large numbers helps, but with X and Y, the error will accumulate from both inaccuracies in tracking position as well as inaccuracies in Z measurement since the conversion from pixel x and y to world X and Y is: X=x·Z·d and Y=−y·Z·d where dis the value representing the size of the object in the world coordinates.

The final step in computing the parameters of the APT involves determining the velocity and acceleration for the X and Y components of motion 716. This is completely analogous to the determination of Z motion 712 as the acceleration is assumed to be relatively constant. For a spinning ball in flight, it has been observed that the spin rate, which is responsible for producing the magnus force, usually does not decay appreciably during the flights of baseballs and golf balls. Therefore, the constant acceleration assumption is reasonable. After independently fitting the equations of motion in X and Y directions, the full 3D APT with respect to the camera position as origin is known and the measurements for the APT are complete. It is important to point out at this stage that these are measurements of the flight which are smoothed by the equations of motion. This differs from some other approaches where the trajectory of the flight is only estimated at times later than those observed. The current embodiment does not rely on these types of predictions as the full flight is measured.

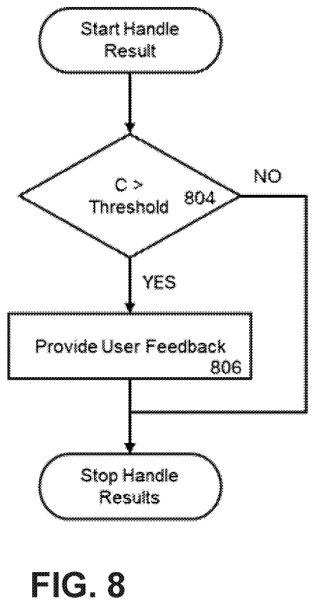

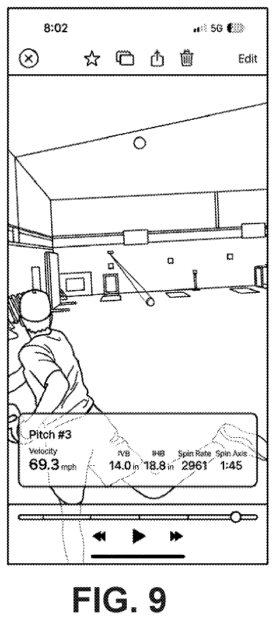

Returning to FIG. 4 the apparatus handles the result 414 of the previous detection, tracking, and computation. The details of this are shown in FIG. 8 where first a decision is made to determine if the result is valid 804. A measured APT passes the criteria of being a valid measurement if any number of tests for validity pass. The confidence of curve fitting, the starting and ending locations of the APT, the launch velocity, and the acceleration can all be used to check against expectations for the use case. If any of these checks fail, this step can end and the apparatus will return to processing additional frame detections. If all criteria are met, and the measurement is considered valid and feedback 806 to the user will be provided. There are numerous ways to provide feedback and convey aspects of the measured APT to the user. To walk through some examples related to the baseball pitch, the measured APT can be used to classify the type of pitch, it can be used to estimate the spin (and post analysis of the video can measure the spin directly in other embodiments), and can be used to measure the release velocity of the pitch. In this example information conveyed to the user may include: visual depiction of the pitch type and its characteristics as shown in FIG. 9, audio signals including human speech to announce velocity, and vibration to alert the user that a particular pitch type was detected. The feedback can occur instantaneously or can be saved in storage and provided at a later time when the user reviews data. The feedback can be transmitted to other devices including wearables such as smart watches. The feedback can be part of a collection of trajectories stored and used for data analytics. These are some examples of the information conveyed to the user, but this does not preclude other embodiments which may make use of other means.

In this embodiment, one aspect of conveying information to the user includes providing the captured video for playback and potentially later analysis. FIG. 9 shows a screenshot of an example of video playback with detected ball locations displayed as well as various metrics of the detected motion. In the age of social media and video analytics where editing video data is often required, the current embodiment provides an automatic recording which due to the use of the ring buffer is edited precisely around the flight duration. Note that though the video is available for playback, the user is not required to view the video as part of this invention.

While the invention herein disclosed has been described in specific embodiments, it acknowledges that numerous modifications and variations could be made by those skilled in the art without significantly departing from the scope of the invention, which is defined by the appended claims.

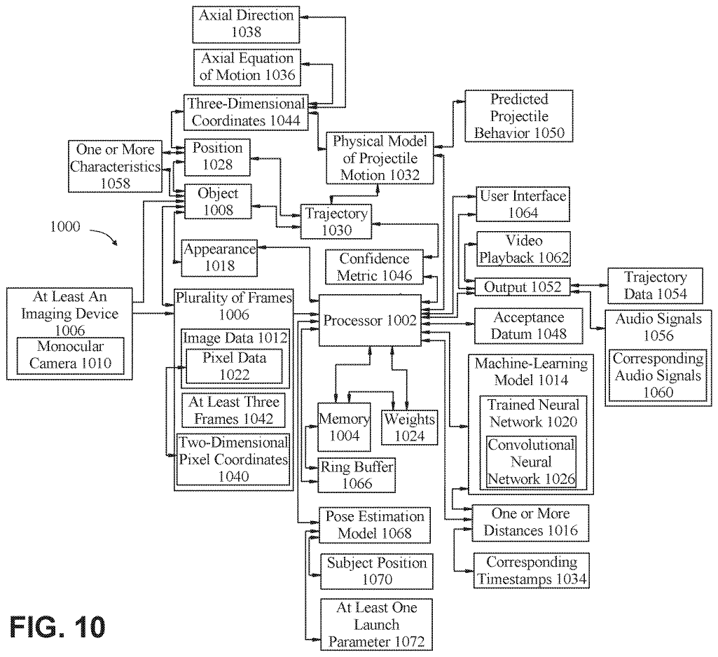

Referring now to FIG. 10, an exemplary embodiment of apparatus or system 1000 for measuring and recording aerodynamic projectile trajectories is illustrated. Apparatus 1000 may include circuitry such as without limitation a processor 1002 communicatively connected to a memory 1004; for instance, circuitry may include and/or be included in a computing device. Memory 1004 may contain instructions configuring processor 1002 to perform any method, method steps, and/or combinations thereof as described in this disclosure. As used in this disclosure, “communicatively connected” means connected by way of a connection, attachment, or linkage between two or more relata such as without limitation electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output 1052 of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Circuitry may alternatively or additionally be implemented by configuring a hardware device such as a combinatorial or sequential logic circuit, an application-specific integrated circuit (ASIC), a field-programmable gate array (FPGA), or other hardware unit; memory 1004 may be attached thereto to further configure the hardware unit using read-only memory 1004 (ROM) or any other static or writable memory 1004 as described in this disclosure. Alternatively or additionally, hardware units and/or modules may be combined with and/or in communication with a processor 1002, such as without limitation in a system-on-chip architecture wherein some functions are configured by modification or design of hardware circuitry, such as without limitation FPGA circuitry, while others are configured in the form of instructions in memory 1004 for one or more processors. As a non-limiting example, any step or combination of steps described herein may be performed entirely using hardware circuit configured to perform such steps either with static memory 1004 or rewritable memory 1004. Such steps or combinations of steps may include signing with a digital signature, cryptographically hashing, evaluation of zero-knowledge proofs, or any other specific process described in this disclosure.

With continued reference to FIG. 10, computing device may be designed and/or configured to perform any method, method step, or sequence of method steps in any embodiment described in this disclosure, in any order and with any degree of repetition. For instance, computing device may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device may perform any step or sequence of steps as described in this disclosure in parallel, such as simultaneously and/or substantially simultaneously performing a step two or more times using two or more parallel threads, processor 1002 cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 10, processor 1002 is configured to capture, using at least an imaging device communicatively connected to at least a processor 1002 and a memory 1004, a plurality of frames 1006 of an object 1008. As used in this disclosure, “imaging device” is a device configured to capture image data representing a physical environment and generate corresponding digital image signals. In an embodiment, an imaging device may include a monocular camera 1010, a stereo camera, a depth sensor, a mobile device camera, and the like. In a non-limiting example, the imaging device may capture sequential image data 1012 at a defined frame rate and provide the image data 1012 to a processor 1002 for real-time or post-processing analysis. Without limitation, the imaging device may include associated optics, sensors, and signal processing circuitry configured to control exposure, focus, gain, compression, and the like. As used in this disclosure, “frame” is a discrete unit of image data representing a scene at a particular point in time. In an embodiment, a frame may include a two-dimensional array of pixel values corresponding to color, intensity, depth, or combinations thereof, and the like. In a non-limiting example, the frame may be one of a plurality of sequentially captured image samples forming a video stream used for motion analysis. Continuing the previous non-limiting example, the frame may be associated with a timestamp or temporal index enabling correlation of object 1008 position 1028 across multiple frames 1006. As used in this disclosure, “object” is a physical entity within a captured scene that is detectable and trackable within image data. In an embodiment, an object 1008 may include a sports ball, a projectile, a vehicle, a person, equipment, and the like. In a non-limiting example, the object 1008 may be identified within image data 1012 using a machine-learning model 1014 configured to detect features, boundaries, or patterns corresponding to the object 1008. Without limitation, the object 1008 may be tracked across multiple frames 1006 to determine positional, kinematic, or trajectory-related information. The imaging device may be communicatively connected to the processor 1002 and the memory 1004 through one or more wired or wireless communication pathways configured to enable transmission of image data 1012, control signals, and synchronization information. In an embodiment, the imaging device may be coupled to the processor 1002 via a direct physical interface including a data bus, a serial interface, a peripheral interconnect, a universal serial bus connection, a camera serial interface, and the like, wherein the processor 1002 receives raw or pre-processed image data 1012 for storage and analysis. In another non-limiting example, the imaging device may be communicatively connected through a wireless interface including Wi Fi, Bluetooth, cellular communication, near-field communication, or other radio frequency communication protocols, and the like, enabling remote or distributed capture of frames 1006 and transmission to the processor 1002 and memory 1004. Without limitation, the imaging device, processor 1002, and memory 1004 may be integrated within a single device such as a smartphone, tablet, embedded system, wearable device, or the like, or may be distributed across multiple devices interconnected via a network, such as a cloud-based processing system receiving frames 1006 from a remote camera. In an embodiment, the processor 1002 may coordinate operation of the imaging device by transmitting control instructions relating to frame rate, exposure settings, resolution, triggering events, and synchronization timing, and the like, while concurrently receiving captured frames 1006 for storage in the memory 1004. In a non-limiting example, the memory 1004 may include volatile memory 1004, non-volatile memory 1004, cache memory 1004, buffer structures, ring buffers 1066, or distributed storage systems, and the like, configured to store the plurality of frames 1006 either temporarily for real-time processing or persistently for post-event analysis. Continuing the previous non-limiting example, the processor 1002 may implement buffering strategies to manage differences between capture rate and processing throughput, including selectively storing, compressing, or skipping frames 1006 to maintain system performance. Without limitation, the communicative connection may further support bidirectional data exchange enabling feedback from the processor 1002 to the imaging device for adaptive capture control based on detected characteristics of the object 1008 in flight.

With continued reference to FIG. 10, the at least an imaging device may include a monocular camera 1010. As used in this disclosure, “monocular camera” is an imaging device comprising a single optical sensor configured to capture two-dimensional image data from a single viewpoint. In an embodiment, a monocular camera 1010 may include a smartphone camera, a webcam, a security camera, an embedded camera module, and the like. In a non-limiting example, the monocular camera 1010 may capture a sequence of frames 1006 representing a scene over time without providing direct stereoscopic depth information. Without limitation, the monocular camera 1010 may be configured with adjustable parameters including focal length, exposure, frame rate, resolution, and the like, to facilitate capture of objects in motion. The monocular camera 1010 may be configured to capture a plurality of frames 1006 from a single viewpoint such that each frame comprises two-dimensional pixel data 1022 representing the object 1008 in flight within a field of view of the monocular camera 1010. In an embodiment, the processor 1002 may receive the plurality of frames 1006 from the monocular camera 1010 and determine spatial characteristics of the object 1008 based on variations in the object 1008's appearance 1018, position 1028, and scale across the plurality of frames 1006. In a non-limiting example, the processor 1002 may utilize one or more computational models to infer depth, distance, or trajectory 1030 information from the two-dimensional image data 1012 captured by the monocular camera 1010, thereby enabling three-dimensional analysis without requiring multiple cameras. Without limitation, the monocular camera 1010 may operate in coordination with the processor 1002 and memory 1004 to support real-time capture and analysis, or may store captured frames 1006 for subsequent processing, depending on system constraints and application requirements.

Still referring to FIG. 10, processor 1002 is configured to receive, from the at least an imaging device, the plurality of frames 1006, wherein the plurality of frames 1006 comprise image data 1012 representing the object 1008. In an embodiment, the object 1008 may be in flight. As used in this disclosure, “image data” is digital information representing visual content captured by an imaging device. In an embodiment, image data 1012 may include pixel intensity values, color channel data, grayscale values, depth-related values, metadata, and the like. In a non-limiting example, the image data 1012 may be organized as a two-dimensional array of pixels corresponding to spatial locations within a frame captured by an imaging device. Without limitation, the image data 1012 may further include temporal information, encoding information, compression artifacts, or auxiliary data associated with capture conditions, and the like. The plurality of frames 1006 may each include image data 1012 corresponding to successive points in time such that the object 1008 in flight is represented at different spatial positions across the plurality of frames 1006. In an embodiment, the processor 1002 may extract features from the image data 1012 including pixel coordinates, object 1008 boundaries, intensity gradients, texture patterns, and the like, to identify and track the object 1008 across the plurality of frames 1006. In a non-limiting example, the processor 1002 may analyze changes in the image data 1012 over time to determine motion characteristics of the object 1008 including displacement, velocity, acceleration, and trajectory 1030. Without limitation, the image data 1012 may be processed in real-time as frames 1006 are received or may be stored in memory 1004 for deferred analysis, enabling flexible processing workflows depending on system capabilities and application requirements.

Still referring to FIG. 10, processor 1002 may compress, using a compression process, the plurality of frames. As used in this disclosure, “compression process” is a computational procedure that reduces the amount of data required to represent image data by encoding the image data into a more compact form while preserving at least a portion of the information content. In an embodiment, a compression process may include applying spatial, temporal, or frequency-domain encoding techniques to reduce redundancy across pixels, frames, or both, such as discrete cosine transforms, predictive encoding, motion compensation, entropy coding, and the like. In a non-limiting example, a compression process may encode a plurality of frames into a compressed video format where successive frames share encoded differences rather than storing full pixel data for each frame, thereby reducing memory usage and bandwidth requirements. Without limitation, a compression process may be implemented using hardware encoders, software codecs, or hybrid approaches operating in real time or asynchronously relative to frame capture and analysis. In an embodiment, the processor 1002 may interface with a hardware encoder integrated within a system-on-chip, graphics processing unit, image signal processor, or dedicated video encoding circuit, wherein the hardware encoder performs compression operations such as motion estimation, transform coding, quantization, and entropy encoding using fixed-function or semi-programmable circuitry. Such hardware-based implementations may operate in parallel with frame acquisition pipelines, enabling real-time compression of high-resolution or high-frame-rate video streams with reduced latency, lower power consumption, and minimal impact on general-purpose processing resources. In a non-limiting example, the processor 1002 may alternatively or additionally execute a software codec comprising instructions stored in memory 1004 and executed by one or more processing cores, wherein the software codec performs compression using algorithmic implementations of encoding standards, configurable parameters, and adaptive decision logic. Such software-based approaches may allow dynamic adjustment of compression parameters including bitrate, resolution scaling, keyframe intervals, region-of-interest prioritization, and compression profiles, thereby enabling flexible tradeoffs between visual fidelity, computational load, and storage requirements. Continuing the previous non-limiting example, the software codec may selectively compress frames after initial analysis has been performed, thereby preserving uncompressed data for trajectory determination while storing compressed data for playback or transmission. In another non-limiting example, a hybrid approach may be employed in which the processor 1002 coordinates between software-level control logic and hardware-accelerated encoding blocks, such that portions of the compression pipeline including preprocessing, region selection, or metadata tagging are performed in software, while computationally intensive encoding stages are offloaded to dedicated hardware. This arrangement may allow the system to adaptively allocate resources based on workload conditions, such as prioritizing low-latency encoding during live capture or prioritizing higher compression efficiency during post-event processing. In an embodiment, operation in real time may include performing the compression process concurrently with frame capture, detection, tracking, or trajectory computation, wherein frames are compressed as they are received or shortly thereafter, enabling continuous operation without interrupting analytical processing pipelines. In another non-limiting example, asynchronous operation may include deferring compression of certain frames or segments until after critical processing tasks are completed, such as after trajectory determination or validation, thereby allowing higher computational resources to be temporarily allocated to analysis before being reallocated to compression tasks. Continuing the previous non-limiting example, asynchronous compression may be triggered based on buffer thresholds, system idle states, user commands, or completion of tracking events, thereby optimizing overall system throughput and responsiveness. Without limitation, the selection between hardware encoding, software encoding, or hybrid encoding, as well as real-time or asynchronous execution, may be dynamically controlled by the processor 1002 based on system constraints including available processing capacity, memory availability, thermal conditions, power consumption targets, desired latency, and intended use of the compressed data, thereby enabling efficient and scalable operation across a wide range of computing platforms and deployment scenarios. In an embodiment, the processor 1002 may selectively apply the compression process to frames stored within a ring buffer or other memory structure to reduce memory footprint while retaining sufficient visual fidelity for subsequent trajectory determination and playback. In a non-limiting example, the processor 1002 may perform compression concurrently with frame capture, such that uncompressed frames are made available for immediate processing while compressed representations are stored for later retrieval, playback, or post-event analysis. Continuing the previous non-limiting example, the compression process may be configured to balance compression ratio and computational cost based on system constraints including available memory, processing throughput, thermal limits, and power consumption. In another non-limiting example, the processor 1002 may utilize temporal compression by encoding differences between successive frames, thereby reducing redundancy in regions of minimal change while preserving motion-relevant information associated with the object in flight. Without limitation, the compression process may include adaptive techniques where regions of interest containing the object are preserved at higher quality while background regions are compressed more aggressively, thereby maintaining accuracy for trajectory-related computations while optimizing overall resource usage.

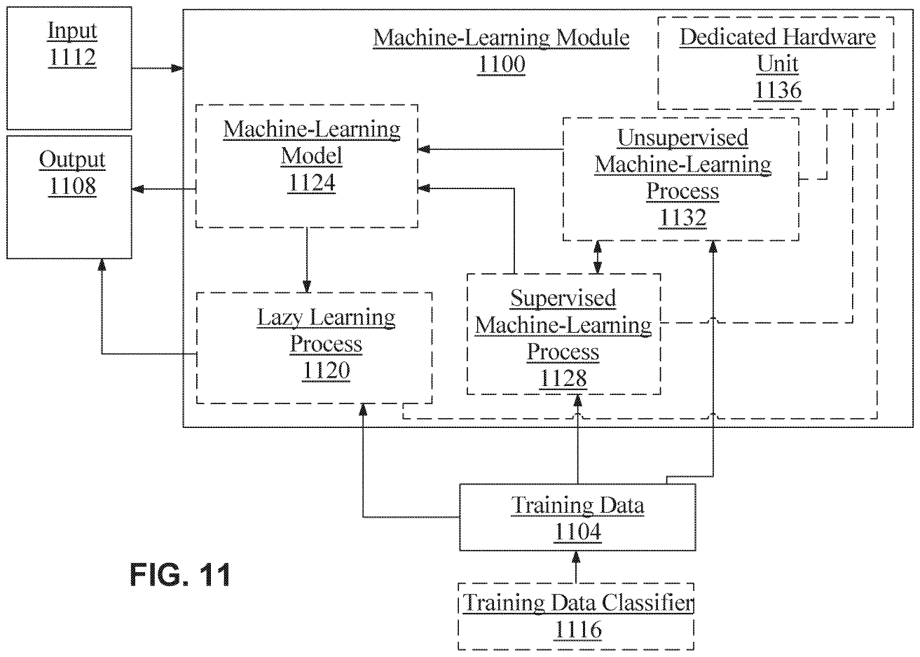

Still referring to FIG. 10, processor 1002 may be configured to determine, using a machine-learning model 1014, one or more distances 1016 between the at least an imaging device and the object 1008 by computing an appearance 1018 of the object 1008. As used in this disclosure, “distance” is a quantitative measure representing a spatial separation between two physical entities within a coordinate system. In an embodiment, a distance may correspond to a separation between an imaging device and an object 1008 along a depth axis, a Euclidean distance in three-dimensional space, a projected distance derived from image data 1012, and the like. In a further embodiment, determining one or more distances may include determining distances across multiple frames, including at least three points, to enable reconstruction of a trajectory of the object. In another embodiment, determining one or more distances may include computing a first distance at a first frame, a second distance at a second frame, and a third distance at a third frame, such that a motion path of the object is inferred. In yet another embodiment, determining one or more distances may include estimating distances at discrete time intervals corresponding to the windowing of frames to derive velocity or acceleration of the object. In a further embodiment, determining one or more distances may include interpolating between distances obtained from successive frames to generate a continuous trajectory representation. In another embodiment, determining one or more distances may include using at least three spatially or temporally distinct measurements to fit a curve corresponding to a projected path of the object. As used in this disclosure, a “point” is a discrete data representation corresponding to a specific spatial and/or temporal position of an object within a coordinate system. In an embodiment, a point may correspond to a detected location of an object within a frame of image data 1012. In another embodiment, a point may correspond to a set of coordinates, including two-dimensional image coordinates or three-dimensional spatial coordinates, associated with the object. In a further embodiment, a point may correspond to a position of the object at a particular time instance, such that a plurality of points across multiple frames may be used to determine motion characteristics, including a trajectory, velocity, or acceleration of the object. In a non-limiting example, the distance may be estimated based on an apparent size, scaling factor, or perspective transformation of the object 1008 as captured in image data 1012. Without limitation, the distance may be determined using computational models including machine-learning models 1014, geometric models, or hybrid approaches, and the like. As used in this disclosure, “appearance” is a set of visual characteristics of an object as represented within image data. In an embodiment, an appearance 1018 may include shape features, color distributions, texture patterns, shading variations, edge information, silhouette representations, and the like. In a non-limiting example, the appearance 1018 may correspond to how an object 1008 is visually perceived within a frame, including variations caused by lighting conditions, motion blur, orientation, and distance relative to an imaging device. Without limitation, the appearance 1018 may be encoded as feature vectors, pixel representations, learned embeddings, or other representations suitable for processing by a machine-learning model 1014, and the like. The machine-learning model 1014 may be the same as or similar to the machine-learning architectures and neural network structures described in FIG. 11 through FIG. 13, including models configured to process image data 1012 and generate outputs based on learned representations. In an embodiment, the processor 1002 may input image data 1012 corresponding to the object 1008 into the machine-learning model 1014, wherein the machine-learning model 1014 extracts appearance 1018-based features and maps those features to one or more estimated distances 1016. In a non-limiting example, the machine-learning model 1014 may infer distance based on correlations between the appearance 1018 of the object 1008 and known spatial relationships learned during training, such as relationships between apparent size, resolution, or visual distortion and physical distance. Without limitation, the processor 1002 may determine the one or more distances 1016 across a plurality of frames 1006 to enable temporal consistency, refinement, or smoothing of distance estimates, thereby improving accuracy of subsequent trajectory 1030 calculations. The processor 1002 may determine the one or more distances 1016 by inputting image data 1012 corresponding to the object 1008 into the machine-learning model 1014, wherein the machine-learning model 1014 processes the appearance 1018 of the object 1008 to extract feature representations indicative of spatial relationships. In an embodiment, the machine-learning model 1014 may analyze characteristics of the appearance 1018 including apparent size, scale variation, texture resolution, edge sharpness, perspective distortion, and the like, and map these characteristics to corresponding distance values based on patterns learned during training. In a non-limiting example, the machine-learning model 1014 may be trained on labeled datasets comprising image data 1012 associated with known distances 1016, enabling the model to infer distance from visual cues present in the appearance 1018 of the object 1008 across varying conditions. In another non-limiting example, the processor 1002 may determine the one or more distances 1016 by evaluating changes in the appearance 1018 of the object 1008 across a plurality of frames 1006, wherein temporal variations such as changes in apparent size or motion-induced scaling are used to refine distance estimates. Without limitation, the machine-learning model 1014 may generate intermediate representations such as feature embeddings or confidence scores that are further processed by the processor 1002 to compute or adjust the one or more distances 1016. In an embodiment, the processor 1002 may combine outputs of the machine-learning model 1014 with additional computational methods including geometric constraints, motion models, or filtering techniques to improve robustness and accuracy of the determined distances 1016. In a non-limiting example, the object 1008 may be a baseball captured within a plurality of frames 1006, wherein the processor 1002 inputs image data 1012 corresponding to the baseball into the machine-learning model 1014. The machine-learning model 1014 may analyze the appearance 1018 of the baseball including an apparent diameter in pixels, seam visibility, texture clarity, and edge definition, and the like, and determine that a larger apparent diameter with sharper texture corresponds to a closer distance while a smaller apparent diameter with reduced detail corresponds to a farther distance. Continuing the previous non-limiting example, the machine-learning model 1014 may output 1052 a first distance value when the baseball appears large and highly resolved in an early frame and a second distance value when the baseball appears smaller in a later frame, thereby enabling the processor 1002 to determine how the distance between the imaging device and the baseball changes over time. Without limitation, the processor 1002 may further refine these distance values by comparing outputs across multiple frames 1006 and applying temporal smoothing or motion constraints to produce a consistent sequence of distance measurements.

With continued reference to FIG. 10, determining the one or more distances 1016 may further include predicting, using a trained neural network 1020 of the machine-learning model 1014, the one or more distances 1016 between the object 1008 and the at least an imaging device based on the appearance 1018 of the object 1008 defined by pixel data 1022 in the plurality of frames 1006, wherein the memory 1004 stores weights 1024 associated with the trained neural network 1020 and wherein the trained neural network 1020 comprises a convolutional neural network 1026. As used in this disclosure, “trained neural network” is a neural network that has been configured through a learning process to map input data to one or more outputs based on learned patterns. In an embodiment, a trained neural network 1020 may be generated by training on labeled datasets comprising input data and corresponding target outputs, and the like. In a non-limiting example, the trained neural network 1020 may be trained using supervised learning, unsupervised learning, semi-supervised learning, reinforcement learning, or combinations thereof, and the like. Without limitation, the trained neural network 1020 may be iteratively updated through optimization processes including gradient descent, backpropagation, loss minimization, and the like, to improve predictive accuracy. As used in this disclosure, “pixel data” is numerical information representing intensity, color, or other visual attributes associated with discrete spatial locations in an image. In an embodiment, pixel data 1022 may include values corresponding to red, green, and blue channels, grayscale intensity values, depth-related values, multi-spectral values, and the like. In a non-limiting example, the pixel data 1022 may be arranged in a structured format such as a matrix or tensor representing spatial relationships between pixels within a frame. Without limitation, the pixel data 1022 may include raw sensor outputs, processed image signals, compressed representations, or normalized values used as input to computational models, and the like. As used in this disclosure, “weights” is a set of adjustable numerical parameters within a neural network that influence how input data is transformed into output data. In an embodiment, weights 1024 may correspond to coefficients applied to input features, convolutional kernels, bias terms, scaling factors, and the like. In a non-limiting example, the weights 1024 may be learned during a training process by adjusting values to minimize a loss function that measures error between predicted outputs and ground truth data. Without limitation, the weights 1024 may be stored in memory 1004 and reused during inference to enable the trained neural network 1020 to generate predictions based on new input data. As used in this disclosure, “convolutional neural network” is a neural network architecture configured to process spatially structured data using convolutional operations. In an embodiment, a convolutional neural network 1026 may include one or more convolutional layers, pooling layers, activation functions, normalization layers, fully connected layers, and the like. In a non-limiting example, the convolutional neural network 1026 may apply learned filters across pixel data 1022 to detect features such as edges, textures, shapes, and hierarchical patterns. Without limitation, the convolutional neural network 1026 may be configured to process image data 1012, video data, or other grid-like data structures to generate feature representations for classification, detection, regression, or other predictive tasks. The trained neural network 1020 may be trained using large datasets of image data 1012 containing objects at known distances 1016, wherein each training sample includes pixel data 1022 and corresponding ground truth distance values, enabling the network to learn relationships between appearance 1018 and spatial separation. In an embodiment, the training process may include feeding pixel data 1022 into the convolutional neural network 1026, computing predicted distance outputs, comparing the predicted outputs to ground truth distances 1016 using a loss function, and iteratively updating weights 1024 using backpropagation and optimization algorithms to reduce prediction error. In a non-limiting example, the training data may include variations in lighting conditions, object 1008 orientations, motion blur, backgrounds, camera parameters, and environmental conditions, and the like, to ensure the trained neural network 1020 generalizes across diverse real-world scenarios. In another non-limiting example, the convolutional neural network 1026 may learn hierarchical feature representations, wherein early layers detect low-level features such as edges and textures while deeper layers capture higher-level features such as object 1008 shape and scale, which are correlated with distance. Continuing the previous non-limiting example, the processor 1002 may input pixel data 1022 from each frame into the trained neural network 1020, which applies stored weights 1024 to extract features and generate distance predictions for the object 1008 in each frame. Without limitation, the memory 1004 may store the weights 1024 of the trained neural network 1020 in a format accessible to the processor 1002, enabling efficient inference during real-time or post-processing operation, while additional processing steps such as temporal smoothing, confidence evaluation, or fusion with motion models may further refine the predicted distances 1016. In a non-limiting example, the trained neural network 1020 may be trained using a dataset comprising thousands of labeled images of a baseball captured at known distances 1016 from an imaging device, wherein each image includes pixel data 1022 and an associated ground truth distance value. During training, the convolutional neural network 1026 may process the pixel data 1022 to identify features such as the apparent diameter of the baseball, seam visibility, texture resolution, and edge sharpness, and iteratively adjust weights 1024 to minimize a difference between predicted distances 1016 and the ground truth distances 1016. Continuing the previous non-limiting example, once trained, the processor 1002 may input pixel data 1022 from a captured frame into the trained neural network 1020, wherein the convolutional neural network 1026 applies the stored weights 1024 to compute feature representations and output 1052 a predicted distance, such as determining that a baseball occupying a larger portion of the frame corresponds to a distance of five meters while a smaller representation corresponds to a distance of fifteen meters. In another non-limiting example, the processor 1002 may repeat this process across multiple frames 1006 to generate a sequence of predicted distances 1016, which may be further refined using temporal smoothing or motion constraints to produce a consistent estimate of the object's 1008 trajectory 1030 relative to the imaging device. Without limitation, the trained neural network 1020 may generalize this mapping across varying lighting conditions, backgrounds, and camera configurations based on the diversity of the training data used during the training process.

Still referring to FIG. 10, processor 1002 is configured to determine a position 1028 of the object 1008 within the plurality of frames 1006 based on the appearance 1018 of the object 1008. As used in this disclosure, “position” is a spatial location of an object defined within a coordinate system. In an embodiment, a position 1028 may correspond to two-dimensional coordinates within an image frame, three-dimensional coordinates 1044 relative to an imaging device, pixel-based coordinates, normalized coordinates, or combinations thereof, and the like. In a non-limiting example, the position 1028 may be represented as horizontal and vertical pixel locations within a frame or as spatial coordinates derived from image data 1012 and distance information. Without limitation, the position 1028 may vary over time across a plurality of frames 1006 to represent motion of the object 1008. The processor 1002 may determine the position 1028 by analyzing image data 1012 within each frame to identify regions corresponding to the object 1008 based on its appearance 1018, including features such as shape, edges, contrast, color distribution, and the like. In an embodiment, the processor 1002 may input the image data 1012 into a machine-learning model 1014 configured to detect the object 1008 and output 1052 coordinates corresponding to a location of the object 1008 within the frame, such as a centroid, bounding region, or keypoint representation. In a non-limiting example, the processor 1002 may determine the position 1028 by identifying a region of highest confidence corresponding to the object 1008 and computing a central point of that region to represent the position 1028 within the frame. In another non-limiting example, the processor 1002 may determine the position 1028 across multiple frames 1006 by tracking the object 1008 using temporal consistency, wherein previously determined positions guide detection in subsequent frames 1006 to improve accuracy and reduce computational cost. Continuing the previous non-limiting example, the processor 1002 may combine pixel-based position 1028 information with distance estimates to determine a three-dimensional position 1028 of the object 1008 relative to the imaging device. Without limitation, the processor 1002 may refine the determined position 1028 using filtering techniques, motion models, or confidence metric 1046s to reduce noise and improve stability of the position 1028 across the plurality of frames 1006.

Still referring to FIG. 10, processor 1002 may be configured to determine a trajectory 1030 of the object 1008 as a function of the one or more distances 1016 and the position 1028 of the object 1008 using a physical model of projectile motion 1032. As used in this disclosure, “trajectory” is a path of motion of an object through space over time. In an embodiment, a trajectory 1030 may be represented as a sequence of spatial positions associated with corresponding time values, a continuous function describing motion in one or more dimensions, or a set of parametric equations defining motion relative to a coordinate system, and the like. In a non-limiting example, the trajectory 1030 may include components corresponding to horizontal, vertical, and depth directions derived from image data 1012 and distance measurements. Without limitation, the trajectory 1030 may further include derived kinematic properties including velocity, acceleration, curvature, and direction of motion, and the like. As used in this disclosure, “physical model of projectile motion” is a mathematical representation describing motion of an object under one or more physical forces acting on the object. In an embodiment, a physical model of projectile motion 1032 may include equations of motion incorporating gravity, drag forces, lift forces, initial velocity, acceleration, and the like. In a non-limiting example, the physical model of projectile motion 1032 may approximate motion using constant or variable acceleration terms along one or more axes based on observed data. Without limitation, the physical model of projectile motion 1032 may be used to fit measured position 1028 and distance data to determine parameters describing the motion of the object 1008. The processor 1002 may determine the trajectory 1030 by combining position 1028 information derived from image data 1012 with distance estimates to generate spatial coordinates of the object 1008 across a plurality of frames 1006, wherein each coordinate corresponds to a point in time. In an embodiment, the processor 1002 may fit the spatial coordinates to the physical model of projectile motion 1032 by estimating parameters including initial position 1028, initial velocity, and acceleration components along one or more axes. In a non-limiting example, the processor 1002 may apply curve fitting or optimization techniques to minimize error between observed positions and positions predicted by the physical model, thereby generating a smooth and physically consistent trajectory 1030. In another non-limiting example, the processor 1002 may determine the trajectory 1030 by computing motion along a depth axis using the one or more distances 1016 and computing lateral motion using pixel-based position 1028 scaled by the distance, thereby reconstructing a three-dimensional path of the object 1008 relative to the imaging device. Continuing the previous non-limiting example, the processor 1002 may refine the trajectory 1030 by enforcing constraints of the physical model of projectile motion 1032, such as near-constant acceleration or expected aerodynamic behavior, to reduce noise and improve accuracy. Without limitation, the resulting trajectory 1030 may be used to derive additional motion characteristics, validate observed behavior, or generate outputs for visualization, analysis, or user feedback.

With continued reference to FIG. 10, the at least a processor 1002 may be further configured to calculate, using the one or more distances 1016 and corresponding timestamps 1034 of the plurality of frames 1006, an axial equation of motion 1036 by fitting the one or more distances 1016 to the physical model of projectile motion 1032 along an axial direction 1038, determine, using the machine-learning model 1014, two-dimensional pixel coordinates 1040 of the object 1008 in at least three frames 1042 1006 of the plurality of frames 1006, and calculate three-dimensional coordinates 1044 of the object 1008 relative to the at least an imaging device by combining the two-dimensional pixel coordinates 1040 with at least one of the one or more distances 1016 or the axial equation of motion 1036. As used in this disclosure, “corresponding timestamps” is temporal data associated with image data that indicates a time at which each frame is captured. In an embodiment, corresponding timestamps 1034 may include absolute time values, relative time offsets, frame indices mapped to time intervals, synchronized clock values, and the like. In a non-limiting example, corresponding timestamps 1034 may be used to associate each frame with a specific point in time to enable temporal analysis of object 1008 motion. Without limitation, corresponding timestamps 1034 may be derived from system clocks, hardware timers, metadata, or inferred timing relationships, and the like. As used in this disclosure, “axial equation of motion” is a mathematical expression describing motion of an object along a defined axis as a function of time. In an embodiment, an axial equation of motion 1036 may include position 1028, velocity, and acceleration terms corresponding to motion along a single axis, and the like. In a non-limiting example, the axial equation of motion 1036 may follow a kinematic model in which position 1028 varies as a function of initial position 1028, initial velocity, and acceleration over time. Without limitation, the axial equation of motion 1036 may be derived by fitting observed data to a physical model of projectile motion 1032 along the defined axis. As used in this disclosure, “axial direction” is a defined directional axis within a coordinate system along which motion is measured. In an embodiment, an axial direction 1038 may correspond to a depth axis extending between an imaging device and an object 1008, a vertical axis aligned with gravity, a horizontal axis, or combinations thereof, and the like. In a non-limiting example, the axial direction 1038 may be selected as a primary direction of motion of the object 1008 to simplify modeling and analysis. Without limitation, the axial direction 1038 may be defined relative to the orientation of the imaging device or an external reference frame. As used in this disclosure, “two-dimensional pixel coordinates” is a pair of values representing a location of a pixel within an image frame along two orthogonal axes. In an embodiment, two-dimensional pixel coordinates 1040 may include horizontal and vertical indices corresponding to positions within a pixel grid, normalized coordinate values, sub-pixel coordinates, and the like. In a non-limiting example, the two-dimensional pixel coordinates 1040 may be used to indicate a detected position 1028 of an object 1008 within a frame based on image data 1012. Without limitation, the two-dimensional pixel coordinates 1040 may be expressed in integer or floating-point form and may be transformed into other coordinate systems for further processing. The processor 1002 may calculate the axial equation of motion 1036 by associating each distance value with a corresponding timestamp and fitting the sequence of distance values over time to a kinematic model describing motion along the axial direction 1038. In an embodiment, the processor 1002 may estimate parameters including initial position 1028, initial velocity, and acceleration along the axial direction 1038 by minimizing error between measured distances 1016 and values predicted by the axial equation of motion 1036. In a non-limiting example, the processor 1002 may determine two-dimensional pixel coordinates 1040 of the object 1008 in at least three frames 1042 1006 by inputting image data 1012 into a machine-learning model 1014 configured to output 1052 spatial coordinates corresponding to the detected object 1008 location within each frame. In another non-limiting example, the processor 1002 may calculate three-dimensional coordinates 1044 by combining the two-dimensional pixel coordinates 1040 with the one or more distances 1016 such that the pixel coordinates are scaled or transformed based on the distance values to produce spatial coordinates relative to the imaging device. Continuing the previous non-limiting example, the processor 1002 may alternatively use the axial equation of motion 1036 to refine or replace individual distance measurements when computing three-dimensional coordinates 1044, thereby improving consistency across frames 1006. Without limitation, the processor 1002 may utilize multiple frames 1006 to generate a sequence of three-dimensional coordinates 1044 representing motion of the object 1008 over time, which may be used for trajectory 1030 determination, motion analysis, or further processing. In a non-limiting example, the object 1008 may be a baseball captured in three frames 1006 at times t1, t2, and t3, wherein corresponding timestamps 1034 indicate that the frames 1006 were captured at 0.00 seconds, 0.02 seconds, and 0.04 seconds, and the like. The processor 1002 may determine distances 1016 of ten meters, eight meters, and six meters for the baseball at the respective timestamps and fit these values to an axial equation of motion 1036 along a depth axis extending between the imaging device and the baseball, thereby estimating a velocity and acceleration along that axis. In the same frames 1006, the processor 1002 may determine two-dimensional pixel coordinates 1040 of the baseball such as pixel locations of 500 by 300, 520 by 290, and 545 by 275, and the like, representing horizontal and vertical positions of the baseball within each frame. Continuing the previous non-limiting example, the processor 1002 may calculate three-dimensional coordinates 1044 by combining the pixel coordinates with the corresponding distances 1016 such that the pixel coordinates are scaled based on the distance values to generate spatial coordinates relative to the imaging device, resulting in positions such as X1 Y1 Z1, X2 Y2 Z2, and X3 Y3 Z3 corresponding to each timestamp. Without limitation, the processor 1002 may further refine the Z components of these coordinates using the axial equation of motion 1036 instead of raw distance values to reduce noise and ensure physically consistent motion, thereby producing a smooth three-dimensional representation of the baseball's trajectory 1030 through space.

With continued reference to FIG. 10, the at least a processor 1002 may be further configured to generate the trajectory 1030 by fitting the three-dimensional coordinates 1044 over time to the physical model of projectile motion 1032. The processor 1002 may generate the trajectory 1030 by associating each three-dimensional coordinate with a corresponding timestamp and analyzing how the spatial position 1028 of the object 1008 evolves over time. In an embodiment, the processor 1002 may apply a curve fitting process to the sequence of three-dimensional coordinates 1044 such that the coordinates conform to equations defined by the physical model of projectile motion 1032, including position 1028 as a function of initial position 1028, velocity, and acceleration. In a non-limiting example, the processor 1002 may determine parameters including initial velocity components and acceleration components along each axis by minimizing a difference between observed three-dimensional coordinates 1044 and coordinates predicted by the physical model. A curve fitting process may include computational procedures configured to determine one or more mathematical functions that approximate observed data points representing motion of an object 1008 over time. In an embodiment, the processor 1002 may receive a plurality of three-dimensional coordinates 1044 associated with corresponding timestamps 1034 and select a functional form based on a physical model of projectile motion 1032, such as equations including position 1028, velocity, and acceleration terms along one or more axes. The processor 1002 may then estimate parameters of the selected function, including initial position 1028, initial velocity, and acceleration components, by minimizing an error between observed coordinates and values predicted by the function. In a non-limiting example, the processor 1002 may implement a least squares optimization process in which squared differences between observed coordinate values and predicted coordinate values are summed and minimized to determine optimal parameter values. Continuing the previous non-limiting example, the processor 1002 may iteratively adjust parameters using numerical optimization techniques such as gradient descent, closed-form solutions, or matrix-based solvers until convergence criteria are satisfied. Without limitation, the curve fitting process may be performed independently for each axis or jointly across multiple axes, and may incorporate constraints derived from the physical model, such as constant or near-constant acceleration, to ensure that the resulting fitted curve represents physically plausible motion. In another non-limiting example, the curve fitting process may incorporate filtering techniques such as Kalman filtering, smoothing algorithms, or weighted regression, wherein measurements with higher confidence are given greater influence in the fitting process. Continuing the previous non-limiting example, the processor 1002 may update the fitted curve as additional data becomes available, enabling real-time refinement of the trajectory 1030 while maintaining consistency with previously observed motion. Without limitation, the curve fitting process may improve robustness to noise, missing data, or measurement error by leveraging redundancy across multiple frames 1006 and enforcing consistency with expected projectile dynamics. In a non-limiting example, the processor 1002 may receive three-dimensional coordinates 1044 of a baseball at three timestamps, such as at 0.00 seconds the coordinates are 0 meters, 1.5 meters, 10 meters, at 0.02 seconds the coordinates are 0.2 meters, 1.4 meters, 8 meters, and at 0.04 seconds the coordinates are 0.5 meters, 1.2 meters, 6 meters, and the like. The processor 1002 may select a physical model of projectile motion 1032 in which position 1028 along each axis is represented as a function of time including initial position 1028, velocity, and acceleration terms. The processor 1002 may then apply a least squares curve fitting process to determine parameter values such that predicted positions from the model closely match the observed coordinates, for instance determining that the object 1008 has an initial forward velocity and a downward acceleration consistent with gravity. Continuing the previous non-limiting example, the processor 1002 may compute predicted positions at each timestamp using the fitted parameters and compare them to the observed coordinates, iteratively adjusting the parameters until the differences are minimized. Without limitation, if one coordinate measurement is noisy or inconsistent, the curve fitting process may reduce its influence by averaging across all observations, resulting in a smooth trajectory 1030 that more accurately reflects the true motion of the baseball rather than the raw measured points. In another non-limiting example, the processor 1002 may generate the trajectory 1030 by fitting separate equations of motion along each axis, including a depth axis, a horizontal axis, and a vertical axis, and combining the resulting equations to form a continuous three-dimensional path of the object 1008. Continuing the previous non-limiting example, the processor 1002 may use optimization techniques such as least squares fitting or iterative refinement to reduce noise and ensure that the generated trajectory 1030 is smooth and physically consistent with expected projectile behavior. Without limitation, the processor 1002 may further validate or adjust the generated trajectory 1030 based on constraints of the physical model, enabling accurate reconstruction of the object 1008's motion even when individual coordinate measurements contain error or variability.

With continued reference to FIG. 10, the at least a processor 1002 may be further configured to calculate a confidence metric 1046 associated with the trajectory 1030 and determine an acceptance datum 1048 of the trajectory 1030 based on the confidence metric 1046. As used in this disclosure, “confidence metric” is a quantitative value representing a level of reliability or accuracy associated with a computed result. In an embodiment, a confidence metric 1046 may be derived from an error measurement, a residual value, a statistical likelihood, a model output 1052 score, or combinations thereof, and the like. In a non-limiting example, the confidence metric 1046 may indicate how closely observed data matches values predicted by a model used to generate a trajectory 1030. Without limitation, the confidence metric 1046 may be expressed as a scalar value, a normalized score, a probability, or another comparable representation of certainty, and the like. As used in this disclosure, “acceptance datum” is a criterion or threshold used to determine whether a computed result satisfies a predefined condition for validity. In an embodiment, an acceptance datum 1048 may include a minimum confidence threshold, a maximum allowable error, a range of acceptable parameter values, or combinations thereof, and the like. In a non-limiting example, the acceptance datum 1048 may define a condition under which a computed trajectory 1030 is accepted as valid for further use or rejected as unreliable. Without limitation, the acceptance datum 1048 may be predetermined, dynamically adjusted, or learned from historical data, and the like. The processor 1002 may calculate the confidence metric 1046 by comparing the three-dimensional coordinates 1044 of the object 1008 to corresponding values predicted by the fitted physical model of projectile motion 1032, wherein differences between observed and predicted values are used to compute an error metric. In an embodiment, the processor 1002 may compute a residual error for each coordinate and aggregate the residuals across multiple frames 1006 to produce a single confidence metric 1046 representing overall fit quality. In a non-limiting example, the processor 1002 may calculate a mean squared error between observed coordinates and model-predicted coordinates and transform the error into a confidence metric 1046 such that lower error corresponds to higher confidence. In another non-limiting example, the processor 1002 may incorporate additional factors into the confidence metric 1046 including consistency of distance estimates, stability of detected positions across frames 1006, detection confidence scores from a machine-learning model 1014, and temporal continuity of motion, and the like. Continuing the previous non-limiting example, the processor 1002 may normalize or weight these factors to produce a composite confidence metric 1046 representing overall reliability of the trajectory 1030. Without limitation, the processor 1002 may determine the acceptance datum 1048 by comparing the confidence metric 1046 to a predefined or adaptive threshold, wherein the trajectory 1030 is accepted if the confidence metric 1046 exceeds the threshold and rejected otherwise. In an embodiment, the threshold may be dynamically adjusted based on system conditions, historical performance, or application requirements, enabling flexible determination of whether the trajectory 1030 satisfies validity criteria. In a non-limiting example, the processor 1002 may compute a trajectory 1030 for a baseball using ten frames 1006 of data and compare the observed three-dimensional coordinates 1044 at each frame to coordinates predicted by the fitted physical model. The processor 1002 may calculate residual errors such as 0.05 meters, 0.08 meters, 0.04 meters, and the like, across the frames 1006 and compute a mean squared error of 0.004, which may be transformed into a confidence metric 1046 of 0.96 on a scale from 0 to 1. Continuing the previous non-limiting example, the processor 1002 may define an acceptance datum 1048 requiring that the confidence metric 1046 exceed 0.90 for the trajectory 1030 to be considered valid. Since the computed confidence metric 1046 of 0.96 exceeds the threshold, the processor 1002 may determine that the trajectory 1030 satisfies the acceptance datum 1048 and is accepted for further use such as display, storage, or analysis. In another non-limiting example, if the residual errors were larger, such as producing a confidence metric 1046 of 0.65, the processor 1002 may determine that the trajectory 1030 does not satisfy the acceptance datum 1048 and may discard the trajectory 1030 or trigger additional processing to improve accuracy.

Still referring to FIG. 10, processor 1002 is configured to validate the trajectory 1030 based on predicted projectile behavior 1050. As used in this disclosure, “projectile behavior” is a set of motion characteristics exhibited by an object moving under the influence of physical forces during flight. In an embodiment, projectile behavior may include motion governed by gravity, aerodynamic drag, lift forces, initial velocity, acceleration profiles, and the like. In a non-limiting example, projectile behavior may describe how an object 1008 accelerates downward due to gravity while experiencing lateral or vertical deviations caused by spin or air resistance. Without limitation, projectile behavior may be represented by expected patterns of motion derived from physical models, empirical observations, or learned approximations, and the like. The processor 1002 may validate the trajectory 1030 by comparing the generated trajectory 1030 to expected motion patterns defined by the physical model of projectile motion 1032, wherein deviations from expected behavior are evaluated to determine validity. In an embodiment, the processor 1002 may analyze characteristics of the trajectory 1030 including velocity profiles, acceleration consistency, curvature, and directional changes, and the like, to determine whether the motion aligns with predicted projectile behavior 1050. In a non-limiting example, the processor 1002 may determine that a valid trajectory 1030 exhibits a generally smooth path with near-constant acceleration along a vertical axis and continuous motion along a depth axis, whereas abrupt discontinuities or physically implausible accelerations may indicate errors in detection or measurement. In another non-limiting example, the processor 1002 may validate the trajectory 1030 by checking whether derived parameters such as initial velocity, acceleration magnitude, and flight duration fall within expected ranges for the object 1008 being tracked. Continuing the previous non-limiting example, if a computed trajectory 1030 suggests an unrealistic acceleration or a non-physical change in direction inconsistent with projectile motion, the processor 1002 may determine that the trajectory 1030 does not conform to predicted projectile behavior 1050 and may reject or flag the trajectory 1030 for further processing. Without limitation, the validation process may incorporate thresholds, statistical checks, or model-based constraints to ensure that only trajectories consistent with expected physical behavior are accepted. In a non-limiting example, the object 1008 may be a baseball tracked across multiple frames 1006, wherein the processor 1002 determines a trajectory 1030 indicating that the baseball travels forward while gradually descending over time due to gravity. The processor 1002 may compute velocity and acceleration values from the trajectory 1030 and determine that the vertical acceleration is approximately negative 9.8 meters per second squared and that horizontal velocity decreases slightly due to drag, which aligns with expected projectile behavior. Continuing the previous non-limiting example, the processor 1002 may compare the trajectory 1030 to predicted projectile behavior 1050 and confirm that the path is smooth, continuous, and consistent with known motion patterns of a baseball in flight, thereby validating the trajectory 1030. In another non-limiting example, if the computed trajectory 1030 instead shows the baseball abruptly increasing altitude without an external force or exhibiting rapid oscillations inconsistent with aerodynamic motion, the processor 1002 may determine that the trajectory 1030 does not match predicted projectile behavior 1050 and may reject the trajectory 1030 or trigger recalculation. Without limitation, the processor 1002 may use such comparisons to ensure that only physically plausible trajectories are accepted for further analysis or output 1052.

Still referring to FIG. 10, processor 1002 is configured to generate an output 1052 comprising trajectory data 1054 of the trajectory 1030. As used in this disclosure, “output” is data generated by a processor for communication, storage, or presentation to a user or another system. In an embodiment, an output 1052 may include visual data, numerical data, audio signals 1056, haptic signals, structured data, or combinations thereof, and the like. In a non-limiting example, the output 1052 may be formatted for display on a user interface 1064, transmission over a network, or storage in a memory 1004 system. Without limitation, the output 1052 may be generated in real-time or after processing and may include intermediate or final results of computational operations, and the like. As used in this disclosure, “trajectory data” is data representing a path of motion of an object 1008 through space over time. In an embodiment, trajectory data 1054 may include a sequence of spatial coordinates, time-associated position 1028 values, velocity components, acceleration components, derived motion parameters, or combinations thereof, and the like. In a non-limiting example, the trajectory data 1054 may include three-dimensional coordinates 1044 of an object 1008 at multiple timestamps describing the object 1008's motion relative to an imaging device. Without limitation, the trajectory data 1054 may be represented as discrete data points, continuous functions, parametric models, or encoded data structures suitable for analysis or visualization, and the like. The processor 1002 may generate the output 1052 by aggregating the computed trajectory 1030 information including three-dimensional coordinates 1044, timestamps, velocity values, and acceleration values into a structured format suitable for use by downstream systems or user interface 1064. In an embodiment, the processor 1002 may organize the trajectory data 1054 as a sequence of time-indexed data points representing the position 1028 of the object 1008 at each frame, along with associated motion parameters derived from the physical model of projectile motion 1032. In a non-limiting example, the processor 1002 may generate the output 1052 as a data structure including coordinate arrays, parameter values, confidence metric 1046s, and validation indicators, which may be transmitted to a display system to visually render the trajectory 1030 or stored in memory 1004 for later analysis. In another non-limiting example, the processor 1002 may generate the output 1052 by converting the trajectory data 1054 into a visual representation such as overlaying the trajectory 1030 path on captured video frames 1006, generating graphs of position 1028 versus time, or producing numerical summaries of motion characteristics. Continuing the previous non-limiting example, the processor 1002 may also encode the trajectory data 1054 into a standardized format for transmission to external systems including remote servers, analytics platforms, or user devices. Without limitation, the output 1052 may be dynamically updated as new frames 1006 are processed or may be finalized after trajectory 1030 validation, depending on system design and application requirements. In a non-limiting example, the processor 1002 may compute a trajectory 1030 for a baseball and generate trajectory data 1054 including a sequence of three-dimensional coordinates 1044 such as 0 meters, 1.5 meters, 10 meters at 0.00 seconds, 0.2 meters, 1.4 meters, 8 meters at 0.02 seconds, and 0.5 meters, 1.2 meters, 6 meters at 0.04 seconds, along with corresponding velocity and acceleration values, and the like. The processor 1002 may package this trajectory data 1054 into an output 1052 data structure that includes the coordinate sequence, timestamps, initial velocity, acceleration components, and a confidence metric 1046 indicating reliability of the trajectory 1030. Continuing the previous non-limiting example, the output 1052 may be used to trigger one or more downstream tasks, such as initiating a classification process to determine a type of pitch, updating a training analytics system, storing the trajectory data 1054 in a database for historical tracking, or transmitting the trajectory data 1054 to a remote server for further processing. Continuing the previous non-limiting example, the output 1052 comprising trajectory data 1054 may be used to initiate a classification process to determine a type of pitch, wherein the processor 1002 or a downstream computing system inputs the trajectory data 1054 into a classification model configured to analyze motion characteristics including velocity profile, curvature, spin-induced deviation, and release angle, and the like. In an embodiment, the classification process may compare the trajectory data 1054 to known pitch archetypes such as fastball, curveball, slider, changeup, and the like, and output 1052 a classification label along with confidence values indicating similarity to each archetype. In another non-limiting example, the classification process may operate in real-time such that immediately after trajectory 1030 generation, the system provides feedback identifying the pitch type and associated performance metrics. In another non-limiting example, the output 1052 may be used to update a training analytics system, wherein the trajectory data 1054 is aggregated with historical performance data for a user to generate insights related to skill development, consistency, and performance trends. In an embodiment, the training analytics system may compute derived metrics including average velocity, spin-induced movement, release consistency, trajectory 1030 deviation over time, and the like, and may present these metrics through dashboards, reports, or visualizations. Continuing the previous non-limiting example, the system may compare current trajectory data 1054 to prior sessions to identify improvements or regressions, enabling coaching recommendations, automated feedback generation, or personalized training plans. In another non-limiting example, the output 1052 may be stored in a database for historical tracking, wherein the trajectory data 1054 is indexed by attributes including timestamp, user identifier, session identifier, object 1008 type, environmental conditions, and the like. In an embodiment, the database may include structured storage systems such as relational databases, time-series databases, distributed storage systems, or cloud-based storage platforms, and the like, enabling efficient retrieval and analysis of trajectory data 1054 over extended periods. Continuing the previous non-limiting example, stored trajectory data 1054 may be queried to identify long-term trends, generate summaries, or support machine-learning model 1014 retraining using accumulated data. Without limitation, the output 1052 may be transmitted to a remote server for further processing, wherein the processor 1002 sends the trajectory data 1054 over a communication network to a cloud-based or distributed computing system configured to perform additional analysis, aggregation, or model inference. In an embodiment, the remote server may integrate trajectory data 1054 from multiple users or devices to perform large-scale analytics, improve model training, or provide comparative benchmarking across users. Continuing the previous non-limiting example, the remote server may generate enhanced outputs including predictive analytics, simulation results, or recommendations, which are then transmitted back to a user device for display or further action. In another non-limiting example, the output 1052 may be used to generate a visual display for a user, such as overlaying the computed trajectory 1030 path on video frames 1006, displaying numerical metrics including speed and distance traveled, or generating graphical plots illustrating motion over time. Without limitation, the output 1052 may also be used to trigger alerts, generate audio feedback, or control other systems, such as providing real-time coaching feedback, activating recording or replay functions, or interfacing with wearable devices to convey information about the trajectory 1030.

With continued reference to FIG. 10, the output 1052 may further include audio signals 1056 and wherein the at least a processor 1002 is further configured to map one or more characteristics 1058 of the object 1008 in flight to corresponding audio signals 1060 and generate the corresponding audio signals 1060 for output 1052. As used in this disclosure, “audio signal” is a signal representing sound that may be generated, transmitted, or perceived by an audio system. In an embodiment, an audio signal may include analog signals, digital audio data, synthesized tones, speech signals, or combinations thereof, and the like. In a non-limiting example, the audio signal may be generated by a processor 1002 and output 1052 through a speaker, headphone, or other audio output 1052 device. Without limitation, the audio signal may encode information using variations in frequency, amplitude, duration, waveform, or modulation, and the like. As used in this disclosure, “characteristics” is one or more measurable or derived properties associated with an object or its motion. In an embodiment, characteristics may include velocity, acceleration, trajectory 1030 curvature, spin rate, direction of motion, release angle, flight duration, or combinations thereof, and the like. In a non-limiting example, the characteristics may be derived from trajectory data 1054 generated by a processor 1002 analyzing image data 1012 of an object 1008 in flight. Without limitation, characteristics may represent instantaneous values, aggregated metrics, or model-derived parameters associated with the object 1008. As used in this disclosure, “corresponding audio signal” is an audio signal that is mapped to represent a specific characteristic or set of characteristics. In an embodiment, a corresponding audio signal may encode information about a characteristic through predefined or dynamically generated mappings between the characteristic and one or more audio properties, and the like. In a non-limiting example, the corresponding audio signal may vary in pitch, tone, volume, rhythm, or spoken content based on values of the characteristic. Without limitation, the corresponding audio signal may be generated in real-time or after processing to convey information to a user. Without limitation, the processor 1002 may perform the mapping by associating ranges or values of characteristics with specific audio parameters, such as mapping higher velocity values to higher frequency tones or increased volume levels. In an embodiment, the processor 1002 may generate audio signals 1056 using synthesized tones, pre-recorded audio clips, or speech generation systems that communicate information about the object 1008 in flight. In a non-limiting example, the processor 1002 may determine that a baseball has a velocity of 40 meters per second and map this value to a high-pitched tone or generate a spoken audio signal stating a speed value, thereby providing immediate auditory feedback to a user. In another non-limiting example, the processor 1002 may map trajectory 1030 curvature to variations in tone modulation such that a sharply curving trajectory 1030 produces a rapidly changing pitch while a straight trajectory 1030 produces a steady tone. Continuing the previous non-limiting example, the processor 1002 may map multiple characteristics simultaneously, such as using pitch to represent velocity and rhythm to represent acceleration, thereby encoding multidimensional information within a single audio signal. Without limitation, the generated audio signals 1056 may be output 1052 in real-time during object 1008 tracking or after trajectory 1030 determination to support training feedback, accessibility, or user interaction. In another non-limiting example, the processor 1002 may map a release angle or launch direction of the object 1008 to a spatialized audio signal, wherein the audio signal is emitted with directional characteristics corresponding to the trajectory 1030 of the object 1008. In an embodiment, a trajectory 1030 moving upward and to the right may be represented by an audio signal that pans from a left speaker to a right speaker while increasing in pitch, and the like, providing a spatial auditory representation of motion. Continuing the previous non-limiting example, a downward trajectory 1030 may be represented by a decreasing pitch or descending tonal pattern, enabling a user to perceive directional changes through sound. In another non-limiting example, the processor 1002 may map a confidence metric 1046 or quality of the trajectory 1030 to characteristics of an audio signal such as clarity, distortion, or harmonic richness, wherein higher confidence produces a clear and stable tone while lower confidence produces a distorted or intermittent audio signal. In an embodiment, a highly reliable trajectory 1030 may trigger a clean, continuous tone or a clear spoken confirmation, while a low-confidence trajectory 1030 may result in a broken tone, static-like modulation, or repeated alert signals, and the like. Continuing the previous non-limiting example, the processor 1002 may use these variations to convey not only the motion characteristics of the object 1008 but also the reliability of the computed results, enabling intuitive user interpretation without requiring visual inspection. The use of audio signals 1056 mapped to characteristics of the object 1008 in flight may be important to a user because it enables rapid, intuitive interpretation of complex trajectory 1030 information without requiring continuous visual attention. In an embodiment, a user such as an athlete or coach may be actively engaged in a physical activity and may not be able to view a display in real-time, and the audio signals 1056 may provide immediate feedback regarding performance characteristics such as velocity, trajectory 1030 shape, or quality of execution. In a non-limiting example, a pitcher may receive instantaneous auditory feedback indicating pitch speed or type, allowing the pitcher to make adjustments between repetitions without interrupting training flow. In another non-limiting example, the audio signals 1056 may improve accessibility by enabling users with limited visual access or attention constraints to perceive motion characteristics through sound. Continuing the previous non-limiting example, the mapping of multiple characteristics to different audio properties such as pitch, rhythm, or spatialization may allow a user to simultaneously perceive several aspects of the object 1008's motion in a compact and efficient manner. Without limitation, the use of audio signals 1056 may reduce cognitive load, enhance real-time decision-making, and provide a more immersive and responsive user experience, particularly in dynamic environments where visual interfaces are impractical or delayed.

Still referring to FIG. 10, processor 1002 is configured to transmit the output 1052 to a user. As used in this disclosure, “user” is an entity that receives, interacts with, or utilizes output generated by a system. In an embodiment, a user may include a human operator, an athlete, a coach, an analyst, a viewer, or the like. In a non-limiting example, the user may also include a computing system, software application, remote server, or automated process configured to receive and act upon the output 1052. Without limitation, the user may interact with the system directly through a device or indirectly through one or more intermediary systems, and the like. The processor 1002 may transmit the output 1052 through one or more communication pathways configured to deliver the trajectory data 1054 or associated information to the user in a usable format. In an embodiment, the processor 1002 may transmit the output 1052 to a display device, wherein the output 1052 is rendered visually as text, graphics, or video overlays representing the trajectory 1030 of the object 1008. In a non-limiting example, the processor 1002 may transmit the output 1052 as audio signals 1056 through a speaker or wearable audio device, enabling the user to receive auditory feedback in real-time. In another non-limiting example, the processor 1002 may transmit the output 1052 over a network to a remote device associated with the user, including a smartphone, tablet, computer, wearable device, or cloud-based system, and the like, using communication protocols such as wireless communication, internet-based transmission, or short-range communication. Continuing the previous non-limiting example, the output 1052 may be transmitted as structured data packets, application data, or streaming data that is received and processed by an application executing on the user device. Without limitation, the processor 1002 may transmit the output 1052 in real-time as data is generated or after processing is complete, and may support bidirectional communication enabling the user to provide input, request additional analysis, or control system operation.

With continued reference to FIG. 10, the at least a processor 1002 may be further configured to generate a video playback 1062 of the plurality of frames 1006 and display, using a user interface 1064, the video playback 1062 of the plurality of frames 1006. As used in this disclosure, “video playback” is a presentation of a sequence of frames in temporal order to visually reproduce motion captured by an imaging device. In an embodiment, a video playback 1062 may include rendering of stored frames 1006 at a defined frame rate to simulate continuous motion, and the like. In a non-limiting example, the video playback 1062 may display frames 1006 in real-time or at a later time to enable review of an object 1008 in flight. Without limitation, the video playback 1062 may include synchronized visual elements, overlays, annotations, or augmented data derived from processing of the frames 1006, and the like. The processor 1002 may generate the video playback 1062 by retrieving stored frames 1006 from memory 1004 and rendering the frames 1006 sequentially according to corresponding timestamps 1034 or a defined playback rate such that motion of the object 1008 is visually reconstructed. In an embodiment, the processor 1002 may synchronize the playback with trajectory data 1054 such that graphical overlays including trajectory 1030 paths, object 1008 markers, velocity indicators, or other annotations are displayed in alignment with the frames 1006. In a non-limiting example, the processor 1002 may display the video playback 1062 on a user interface 1064 of a device including a smartphone, tablet, computer, or wearable display, enabling the user to review the motion of the object 1008 alongside computed metrics. In another non-limiting example, the processor 1002 may provide interactive playback controls through the user interface 1064 including play, pause, rewind, slow motion, frame-by-frame navigation, and the like, allowing the user to analyze specific portions of the object 1008's motion in detail. Continuing the previous non-limiting example, the processor 1002 may dynamically update displayed overlays or metrics during playback to reflect processed trajectory data 1054, thereby integrating visual and analytical information. Without limitation, the video playback 1062 may be generated in real-time during capture or after processing is complete, and may be stored, transmitted, or shared with other systems or users for further analysis or review. As used in this disclosure, a “user interface” is a collection of hardware and/or software components configured to enable interaction between a user and a computing device, wherein the user interface facilitates the presentation of data to the user and the reception of input from the user. The user interface 1064 may include, without limitation, graphical user interfaces, command-line interfaces, application programming interfaces, voice-based interfaces, haptic interfaces, or augmented reality interfaces. A “graphical user interface,” as used herein, is a graphical form of user interface 1064 that allows users to interact with electronic devices. In some embodiments, GUI may include icons, menus, other visual indicators or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pull-down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface. For example, links to decentralized platforms as described in this disclosure may be incorporated using icons. Using an icon may be a fast way to open documents, run programs etc. because clicking on them yields instant access.

With continued reference to FIG. 10, in an embodiment, the graphical user interface and an event handler may operate together to enable seamless interaction between the user and the apparatus 1000. The GUI serves as the visual and interactive layer through which the user engages with the apparatus 1000, presenting elements such as buttons, sliders, input fields, and informational displays. The event handler, on the other hand, functions as the underlying mechanism that monitors and responds to user interactions with the GUI. For example, when a user clicks a button on the GUI to request an explanation of a concept, the event handler may detect the click event, identify its context, and trigger the appropriate processes within the apparatus 1000 to generate a tailored response. This interplay may ensure dynamic and responsive system behavior, as the event handler processes various input events such as clicks, taps, keystrokes, or voice commands, and relays these inputs to the relevant system components. The GUI subsequently updates to reflect the system's responses, such as displaying output 1052, modifying visual elements, or providing real-time feedback. Together, the GUI and event handler create an intuitive and interactive experience, bridging user actions and system functionality to achieve efficient and personalized outcomes.

With continued reference to FIG. 10, an “event handler,” as used in this disclosure, is a module, data structure, function, and/or routine that performs an action in response to an event. For instance, and without limitation, an event handler may record data corresponding to user selections of previously populated fields such as drop-down lists and/or text auto-complete and/or default entries, data corresponding to user selections of checkboxes, radio buttons, or the like, potentially along with automatically entered data triggered by such selections, user entry of textual data using a keyboard, touchscreen, speech-to-text program, or the like. Event handler may generate prompts for further information, may compare data to validation rules such as requirements that the data in question be entered within certain numerical ranges, and/or may modify data and/or generate warnings to a user in response to such requirements.

With continued reference to FIG. 10, as used in this disclosure, a “visual element” is a component or feature within a system, display, or interface that conveys information through visual means. In a non-limiting example, the visual element may include text, images, icons, shapes, colors, and/or other graphical components designed to be perceived by the user. In a non-limiting example, the visual element may aid in communication, navigation, and/or interaction with the system. Without limitation, the visual element may be used to enhance user experience, guide behavior, and/or represent data visually in an intuitive or informative way. A visual element may include data transmitted to display device, client device, and/or graphical user interface. In some embodiments, visual element may be interacted with. For example, visual element may include an interface, such as a button or menu. In some embodiments, visual element may be interacted with using a user device such as a smartphone, tablet, smartwatch, or computer.

With continued reference to FIG. 10, the at least a processor 1002 may be further configured to generate the output comprising the video playback of the plurality of frames and display, using the user interface, the video playback of the plurality of frames, wherein the video playback comprises at least an overlay of one or more trajectory metrics corresponding to the trajectory and a tracer corresponding to the trajectory. As used in this disclosure, “overlay” is a visual element or set of visual elements rendered in association with underlying image or video data such that the visual element is superimposed or composited with the underlying data without replacing the underlying data. In an embodiment, an overlay may include graphical annotations such as lines, curves, text labels, color gradients, markers, and the like displayed over video frames to convey analytical information. In a non-limiting example, an overlay may be dynamically generated in real time to indicate a computed trajectory path aligned with an object's motion within a video playback. Without limitation, an overlay may be rendered using hardware acceleration, software rendering pipelines, augmented reality techniques, or combinations thereof, and the like. As used in this disclosure, “trajectory metric” is a quantitative value or set of values derived from a trajectory that characterizes one or more physical, geometric, temporal, or kinematic properties of motion along the trajectory. In an embodiment, a trajectory metric may include velocity, acceleration, curvature, displacement, spin-related values, release parameters, or other motion descriptors, and the like. For example, without limitation, a trajectory metric may be computed from time-indexed positional data to represent instantaneous or aggregate motion characteristics of an object. In another non-limiting example, a trajectory metric may be presented as numerical values, graphical indicators, comparative scores, or classifications derived from the trajectory for user interpretation. As used in this disclosure, “tracer” is a visual representation that depicts a path or progression of an object over time within a sequence of frames by marking one or more historical or predicted positions of the object. In an embodiment, a tracer may include a tracer overlay configured to be rendered on a frame retrieved from the ring buffer such that visual information associated with motion, position, or event context is superimposed onto the frame. In a non-limiting example, the tracer may include a tracer overlay comprising graphical elements such as lines, markers, heatmaps, bounding regions, opacity variations, and the like that represent trajectories or detected features derived from 1 or more frames. Without limitation, the tracer may include a tracer overlay that is dynamically generated based on analysis of a plurality of frames and composited onto a selected frame to provide a temporal visualization within a single displayed image. In an embodiment, a tracer may include a continuous or segmented line connecting detected object positions across frames to illustrate motion. In a non-limiting example, a tracer may be rendered as a fading trail, discrete points, or color-coded segments corresponding to temporal progression of the object. Without limitation, a tracer may be generated using stored positional data, predicted trajectory data, interpolated motion paths, or combinations thereof, and the like. In an embodiment, the processor 1002 may retrieve stored frames from a memory structure including a ring buffer or persistent storage and reconstruct a temporally ordered video stream representing motion of the object, wherein synchronization with corresponding timestamps enables accurate temporal alignment of visualized data. In a non-limiting example, the processor 1002 may render the overlay concurrently with playback by compositing graphical elements representing trajectory metrics such as velocity, acceleration, spin-related parameters, displacement, and the like directly onto each frame based on time-correlated trajectory data derived from the physical model of projectile motion. In another non-limiting example, the tracer corresponding to the trajectory 1030 may be generated by mapping historical and optionally predicted three-dimensional coordinates of the object into the two-dimensional coordinate space of each frame, thereby producing a visual path that follows the motion of the object across the video playback 1062. Continuing the previous non-limiting example, the tracer may be dynamically updated as playback progresses, such that earlier positions may be retained, faded, color-shifted, or otherwise visually distinguished to indicate temporal progression and directionality of motion. In an embodiment, the user interface 1064 may include display hardware such as a mobile device screen, augmented reality display, head-mounted display, or external monitor, and may further include software components configured to manage rendering layers, user interaction, and playback controls. Without limitation, the overlay and tracer may be selectively enabled, disabled, or customized by a user through interface controls, allowing adjustment of visual parameters such as opacity, color schemes, scaling, metric selection, and temporal persistence. In an embodiment, the tracer may be rendered as a dotted line pattern to indicate a classified type of throw, wherein different dot spacings or shapes correspond to classifications such as fastball, curveball, slider, changeup, and the like. In a non-limiting example, the overlay may include color-coded trajectory segments where a first color represents increasing velocity, a second color represents decreasing velocity, and a third color represents regions of high curvature or spin-induced movement, thereby visually conveying changes in motion characteristics along the trajectory. In another non-limiting example, the tracer may include a gradient color transition from one color to another along its length to indicate temporal progression, such that an initial release point is shown in one color and a terminal point is shown in another color, with intermediate colors representing intermediate times. Continuing the previous non-limiting example, the overlay may include dynamically scaled markers at discrete points along the trajectory, where marker size corresponds to magnitude of acceleration or confidence values, enabling quick identification of key motion events. In an embodiment, the overlay may include labeled callouts positioned adjacent to the tracer, where each callout displays specific trajectory metrics such as instantaneous velocity, spin rate, or displacement at selected timestamps, and the like. Without limitation, the tracer may be rendered with varying thickness along its path, where increased thickness corresponds to higher confidence measurements or higher speeds, and decreased thickness corresponds to lower confidence or slower speeds. In another non-limiting example, the overlay may include directional arrows placed along the tracer to indicate instantaneous velocity vectors, with arrow orientation corresponding to direction of motion and arrow length corresponding to magnitude of velocity. Continuing the previous non-limiting example, the tracer may include segmented portions that are selectively highlighted or muted based on user-selected filters, such that only portions of the trajectory meeting specified criteria, including threshold velocity ranges, specific spatial regions, or classification outcomes, are emphasized visually while other portions are deemphasized. In a non-limiting example, the processor 1002 may utilize graphics processing resources including a GPU or dedicated rendering engine to efficiently composite overlay elements and tracer visualizations in real time without interrupting playback performance. More particularly, the processor 1002 may cause decoded video frames to be placed in a frame buffer or other renderable memory region while trajectory data, tracer geometry, and metric display data are separately maintained as graphical primitives, texture assets, text objects, or shader inputs. The GPU or dedicated rendering engine may then execute a compositing pipeline in which the underlying video frame is treated as a base visual layer and one or more additional layers corresponding to the overlay and tracer are rendered over the base visual layer according to timing information associated with the current playback position. In an embodiment, the processor 1002 may convert trajectory coordinates and associated metrics into screen-space coordinates prior to submission to the GPU, such that the GPU performs rasterization, blending, anti-aliasing, scaling, transparency adjustment, and text rendering using parallelized graphics operations. In a non-limiting example, the tracer may be represented as a set of connected vertices, line segments, splines, sampled points, or textured path elements, and the GPU may draw those elements using a vertex stage and a fragment stage that determine placement, thickness, opacity, color, and temporal effects. Continuing the previous non-limiting example, a dotted tracer for a classified throw type may be generated by applying a repeating pattern mask or procedural fragment operation along the rendered path, while a color-coded tracer may be generated by assigning color values to segments of the path based on one or more corresponding trajectory metrics such as pitch classification, velocity band, break magnitude, spin-related behavior, confidence level, and the like. In another embodiment, the overlay may be generated as a distinct graphical layer comprising text fields, icons, gauges, metric panels, labels, arrows, and callouts, where each element is bound to a playback timestamp or frame index. The processor 1002 may update only those overlay elements that change between adjacent frames while retaining static graphical assets in GPU memory, thereby reducing repeated computation and memory transfer. Without limitation, this selective updating may permit efficient rendering of changing values such as velocity, release angle, break amount, or confidence while avoiding unnecessary re-rendering of unchanged interface components. In a non-limiting example, the processor 1002 may maintain a synchronization structure linking each playback frame to corresponding trajectory samples, interpolation parameters, and user interface state data. During playback, the processor 1002 may determine a current playback time, identify one or more trajectory samples associated with that time, and provide the GPU with rendering instructions that place the tracer and overlay in alignment with the displayed frame. Where the playback time falls between sampled trajectory points, the processor 1002 or GPU may interpolate position, orientation, color state, or metric values so that the visualized tracer appears temporally smooth and spatially continuous. In another non-limiting example, the dedicated rendering engine may employ double buffering, command queuing, or asynchronous execution such that video decoding, trajectory computation, and graphical compositing occur in overlapping stages rather than in a strictly sequential manner. For example, without limitation, a first buffer may be used to display a current composited frame while a second buffer is simultaneously populated with a subsequent video frame and its associated overlay and tracer elements. This arrangement may reduce visible stutter, latency, or dropped frames and may preserve a desired playback rate even when multiple metrics, labels, and trajectory effects are enabled. In an embodiment, the GPU may further execute shader programs configured to visually distinguish types of information without substantial processor overhead. In a non-limiting example, a fragment shader may assign a first dashed style to a fastball classification, a second dashed style to a slider classification, and a third segmented style to a curveball classification, while also modulating brightness or opacity according to confidence. In another non-limiting example, a shader may color the tracer with a gradient that changes along the path according to elapsed time, or may emphasize regions of high movement by increasing saturation, glow intensity, or line thickness in portions of the trajectory associated with larger deviations from a baseline path. Without limitation, the processor 1002 may offload text compositing, alpha blending, clipping, and geometric transformations to the GPU so that the central processing resources remain available for playback control logic, user input handling, communications, and additional analytical operations. In this manner, the system may preserve responsive playback while simultaneously presenting visually rich analytical information that remains spatially registered with the object and temporally registered with the video playback. In another embodiment, the output 1052 may further include synchronized audio signals, haptic feedback, or data transmission to external devices, wherein the overlay and tracer provide a visual representation while additional modalities reinforce interpretation of trajectory metrics. Without limitation, the generation and display of the overlay and tracer within the video playback 1062 may improve user comprehension of complex motion characteristics by integrating quantitative trajectory analysis directly with visual context, thereby reducing cognitive load and enabling more efficient analysis, training, or performance evaluation across a variety of applications.

With continued reference to FIG. 10, in an embodiment, the apparatus 1000 and or the downstream device may include a data structure. As used in this disclosure, “data structure” is a way of organizing data represented in a specialized format on a computer configured such that the information can be effectively presented in a graphical user interface. In some cases, the data structure includes any input data. In some cases, the data structure contains data and/or rules used to visualize the graphical elements within a graphical user interface. In some cases, the data structure may include any data described in this disclosure. In some cases, the data structure may be configured to modify the graphical user interface, wherein data within the data structure may be represented visually by the graphical user interface. In some cases, the data structure may be continuously modified and/or updated by processor 1002, wherein elements within graphical user interface may be modified as a result. In some cases, processor 1002 may be configured to transmit display device and or the downstream device the data structure. Transmitting may include, and without limitation, transmitting using a wired or wireless connection, direct, or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio, and microwave data and/or signals, combinations thereof, and the like, among others. Processor 1002 may transmit the data described above to a database wherein the data may be accessed from the database. Processor 1002 may further transmit the data above to a display device, client device, or another computing device. The data structure may serve as the organizational framework that stores, retrieves, and manages data required for processing events and updating the GUI. The data structure may act as a bridge between the user's input, captured by the event handler, and the output 1052 displayed on the GUI, ensuring that information is handled efficiently and accurately throughout the interaction. For example, without limitation, when a user interacts with a dropdown menu in the GUI to select a topic, the event handler may capture this input and accesses a data structure. The data structure may retrieve the relevant information such as, text explanations, videos, or interactive exercises, and passes it back to the event handler, which may then trigger the appropriate updates to the GUI. In another embodiment, the data structure may also maintain the state of the system, tracking user progress, preferences, and session history. For instance, without limitation, a hash table may store user specific configurations which the event handler references when processing interactions. The GUI may then dynamically adapt to display content aligned with these configurations. This integration may ensure that user inputs are seamlessly translated into meaningful system outputs, with the data structure enabling rapid access, consistency, and scalability throughout the process. As used in this disclosure, a “hash table” is a data structure that stores data in a way that allows for fast retrieval, insertion, and deletion of elements. The hash table may organize data into key-value pairs, where each key is unique and used to identify its corresponding value. A hash table may use a hash function to compute an index, or hash code, from the key, which determines where the key-value pair is stored within an array or list.

With continued reference to FIG. 10, as used in this disclosure, an “interactive element” is a component or feature within a graphical user interface (GUI) that allows users to perform actions, provide input, or engage with the apparatus 1000. Interactive elements may be designed to facilitate two-way communication between the user and the system, enabling the user to influence the behavior of the apparatus or obtain feedback in response to their actions. Examples of interactive elements may include buttons, dropdown menus, sliders, checkboxes, input fields, and hyperlinks. More advanced interactive elements may include drag-and-drop interfaces, interactive diagrams, or dynamically updating content areas that respond to user actions in real time. The interactive elements may enhance user engagement by providing intuitive and responsive mechanisms for interacting with the system. Interactive elements may operate by responding to user actions such as clicks, taps, swipes, or keyboard inputs, and triggering predefined system behaviors or processes. The execution of the interactive elements may require a combination of front-end and back-end technologies that work together to provide seamless functionality and user interaction. On the front end, technologies such as HTML and CSS may define the structure, appearance 1018, and layout of the interactive elements, while JavaScript may enable dynamic functionality. For example, without limitation, JavaScript may detect when the user clicks a button and trigger actions or animations. Front-end frameworks like React, Angular, or Vue.js may further enhance development by offering reusable components and efficient rendering mechanisms. On the back end, the system may process the user's input, retrieve the necessary data, and communicate with the front end to provide an appropriate response. APIs may act as a bridge between the front end and back end, facilitating data transfer, such as sending a user's form submission to the server and retrieving processed results. Server-side logic, implemented using languages like Python, Java, or Node.js, may handle input processing and return relevant data. Additional supporting technologies may ensure the smooth operation of interactive elements. Event listeners, for instance, may continuously monitor for specific actions like mouse clicks or text entries, executing code when such events are detected. Efficient data structures, such as hash tables or dictionaries, may store interactive state data, such as user preferences or settings, for quick access and updates. Databases, including MySQL or MongoDB, may manage and store the data required for interactive features, such as user profiles or historical activity. Communication technologies may also help maintain the responsiveness of interactive elements. AJAX (Asynchronous Javascript and XML) may allow the front end to update portions of a web page without requiring a full page reload, enhancing responsiveness. WebSockets may provide real-time interaction capabilities, such as live chats or collaborative tools, by enabling persistent communication between the client and the server. Without limitation, the apparatus 1000 may include one or more APIs. As used in this disclosure, an “application programming interface (API)” is a set of defined protocols, tools, and methods that allow different software applications, systems, or components to communicate and interact with each other. An API may act as an intermediary that enables a client application, such as a user-facing app, to send requests to a server or service and receive the necessary responses, facilitating seamless integration and functionality across diverse systems.

With continued reference to FIG. 10, as used in this disclosure, “downstream device” is a device that accesses and interacts with apparatus 1000. For instance, and without limitation, downstream device may include a remote device and/or apparatus 1000. In a non-limiting embodiment, downstream device may be consistent with a computing device as described in the entirety of this disclosure. Without limitation, the downstream device may include a display device. As used in this disclosure, a “display device” refers to an electronic device that visually presents information to the entity. In some cases, display device may be configured to project or show visual content generated by computers, video devices, or other electronic mechanisms. In some cases, display device may include a liquid crystal display (LCD), a cathode ray tube (CRT), a plasma display, a light emitting diode (LED) display, and any combinations thereof. In a non-limiting example, one or more display devices may vary in size, resolution, technology, and functionality. Display device may be able to show any data elements and/or visual elements as listed above in various formats such as, textural, graphical, video among others, in either monochrome or color. Display device may include, but is not limited to, a smartphone, tablet, laptop, monitor, tablet, and the like. Display device may include a separate device that includes a transparent screen configured to display computer generated images and/or information. In some cases, display device may be configured to present a graphical user-interface (GUI) to a user, wherein a user may interact with a GUI. In some cases, a user may view a GUI through display. Additionally, or alternatively, processor 1002 be connected to display device. In one or more embodiments, transmitting the video playback 1062 may include displaying the video playback 1062 at display device using a visual interface.

With continued reference to FIG. 10, the at least a processor is configured to store the compressed plurality of frames in a memory buffer. As used in this disclosure, “memory buffer” is a structured region of memory configured to temporarily store data for access by one or more processing operations during execution. In an embodiment, a memory buffer may store a sequence of frames, compressed video data, intermediate processing results, or metadata associated with frame capture and analysis, and the like. In a non-limiting example, a memory buffer may be implemented as a ring buffer, queue, circular buffer, or dynamically allocated memory structure that maintains recently captured frames for real-time or post-event processing. In an embodiment, a ring buffer implementation may allocate a fixed-size contiguous memory region partitioned into slots corresponding to individual frames, wherein a write pointer advances as new compressed frames are stored and wraps around to the beginning upon reaching the end of the allocated region, thereby overwriting the oldest frames while preserving the most recent temporal windowing of data. This arrangement may enable continuous capture without requiring memory reallocation and may support deterministic timing behavior suitable for real-time systems. In a non-limiting example, a queue-based buffer may maintain an ordered sequence of frames where new frames are appended to a tail position and frames are removed from a head position for processing, thereby enabling first-in-first-out access patterns that align with sequential playback or analysis workflows. Continuing the previous non-limiting example, the processor may dequeue frames for detection or tracking while concurrently enqueuing newly compressed frames, thereby supporting pipelined execution across capture, compression, and analysis stages. In another non-limiting example, a dynamically allocated memory structure may expand or contract based on system conditions, such as increasing capacity when extended motion events are detected or reducing allocation during idle periods to conserve memory resources. Such a structure may utilize linked memory regions, segmented buffers, or managed heaps to accommodate variable-length sequences of frames while maintaining indexing information for efficient retrieval. In an embodiment, the memory buffer may further include metadata structures associated with each stored frame, including timestamps, compression parameters, detection flags, region-of-interest indicators, or confidence values, thereby enabling selective access to frames relevant to trajectory determination. Without limitation, the processor may employ synchronization mechanisms such as locks, semaphores, or lock-free data structures to coordinate concurrent read and write access to the memory buffer, thereby ensuring data consistency while enabling parallel execution of capture, compression, and analysis processes. Without limitation, a memory buffer may be managed to control data flow between capture, compression, analysis, and playback processes by selectively overwriting, retaining, or prioritizing stored data based on system conditions. In an embodiment, the processor 1002 may allocate the memory buffer within volatile memory to enable rapid read and write operations as frames are captured and compressed, thereby supporting near real-time processing pipelines. In a non-limiting example, the processor 1002 may store compressed frames sequentially in the memory buffer while maintaining associated indexing information including timestamps, frame identifiers, or detection flags to facilitate efficient retrieval and analysis. Continuing the previous non-limiting example, the memory buffer may be configured as a circular structure in which older frames are overwritten by newly compressed frames once a capacity threshold is reached, thereby ensuring that the most recent portion of the object's motion is retained for trajectory determination without requiring unbounded memory resources. In another non-limiting example, the processor 1002 may selectively preserve a subset of frames within the memory buffer based on detection of the object or identification of a region of interest, thereby retaining higher relevance data while discarding less relevant background frames. Without limitation, the memory buffer may further support concurrent access patterns in which one process writes compressed frames while another process reads frames for detection, tracking, or trajectory computation, thereby enabling efficient pipeline operation across capture, compression, and analysis stages.

With continued reference to FIG. 10, storing, using the memory buffer, the compressed plurality of frames may include storing the plurality of frames in a ring buffer and refining, using the ring buffer, one or more equations of motion associated with the trajectory, wherein the one or more equations of motion are based on the physical model of projectile motion. As used in this disclosure, “ring buffer” is a data structure that stores data in a fixed-size memory region arranged in a circular manner such that new data overwrites older data when the capacity is reached. In an embodiment, the processor 1002 may insert each compressed frame into successive positions within the ring buffer in accordance with a temporal sequence, such that the ring buffer maintains a rolling windowing of recent frames corresponding to the motion of the object. This rolling windowing may provide a continuously updated dataset from which positional information, velocity estimates, and higher-order motion characteristics may be derived without requiring access to an entire capture sequence. In a non-limiting example, the processor 1002 may retrieve subsets of frames from the ring buffer corresponding to defined temporal intervals and may compute position estimates of the object across those frames using detection outputs, appearance-based estimation, or interpolation techniques. Continuing the previous non-limiting example, the processor 1002 may iteratively update one or more equations of motion by fitting the computed positions and derived kinematic parameters to a physical model of projectile motion, including parameters associated with gravity, drag, spin-induced forces, or other environmental influences. Such refinement may include recalculating coefficients, minimizing error between predicted and observed positions, or adjusting model parameters as additional frames are incorporated into the ring buffer. In another non-limiting example, the ring buffer may enable incremental refinement in which earlier estimates of trajectory are updated as new frame data becomes available, thereby improving accuracy over time without recomputing the trajectory from an initial state. The processor 1002 may, for instance, apply recursive estimation techniques, filtering operations, or optimization routines that incorporate newly stored frame data while retaining prior state information. In an embodiment, recursive estimation may include maintaining a state vector representing the current estimate of position, velocity, and acceleration of the object, wherein each newly processed frame contributes an updated observation that is fused with the prior state to produce a refined estimate. For example, without limitation, the processor 1002 may implement a Kalman filter or extended Kalman filter in which predicted motion based on prior equations of motion is compared with newly observed positions derived from the ring buffer, and discrepancies are used to update the state in a statistically weighted manner. In a non-limiting example, filtering operations may include temporal smoothing, noise reduction, or outlier rejection applied to position, distance, or velocity measurements extracted from successive frames. Continuing the previous non-limiting example, the processor 1002 may assign confidence weights to individual frame measurements and attenuate the influence of frames exhibiting low confidence, motion blur, or detection uncertainty, thereby stabilizing the resulting trajectory and associated equations of motion. In another non-limiting example, optimization routines may include iterative curve fitting, least squares minimization, or gradient-based parameter estimation applied to the equations of motion, wherein parameters such as initial velocity, acceleration components, or drag-related coefficients are continuously refined as additional frame data becomes available. Continuing the previous non-limiting example, the processor 1002 may minimize an error metric representing deviation between observed positions and positions predicted by the physical model, thereby improving model accuracy over time. In an embodiment, these approaches may operate in combination such that recursive estimation provides real-time updates, filtering operations improve robustness to noise, and optimization routines refine global model parameters across a windowing of frames maintained in the ring buffer 1066, thereby enabling progressively improved trajectory determination as additional data is incorporated. Without limitation, the ring buffer may also allow selective retention of frames associated with key motion events, such as release, peak height, or impact, thereby providing anchor points for refining the equations of motion. In an embodiment, the use of the ring buffer for both storage and refinement may enable concurrent execution in which frame insertion, trajectory estimation, and equation refinement occur in overlapping time intervals. For example, without limitation, while new compressed frames are written into the ring buffer, previously stored frames may be read and processed to update motion equations, thereby supporting near real-time trajectory determination. This arrangement may reduce latency in generating trajectory outputs and may improve robustness of the physical model by continuously incorporating newly observed data into the refinement process. In an embodiment, refining the one or more equations of motion may include receiving newly stored frame data from the ring buffer, extracting updated positional and temporal data, and updating a current state estimate associated with the trajectory. In a non-limiting example, the refining process may include predicting a subsequent state of the object using prior equations of motion, comparing the predicted state to observed measurements derived from the newly stored frames, and computing an error value representing a deviation between prediction and observation. Continuing the previous non-limiting example, the refining process may further include weighting the observed measurements based on confidence values, filtering the positional and distance data to reduce noise or discard outliers, and updating the state estimate using a recursive estimation technique. In another non-limiting example, the refining process may include fitting the updated positional data to the physical model of projectile motion, minimizing an error metric using an optimization routine, and recalculating one or more parameters including velocity, acceleration, or higher-order motion terms. In an embodiment, the refining process may additionally include iterating the predicting, comparing, filtering, weighting, updating, and fitting steps across successive frames stored in the ring buffer, thereby continuously improving accuracy of the one or more equations of motion as additional data becomes available.

With continued reference to FIG. 10, the at least a processor 1002 may be further configured to store, using the memory 1004, the plurality of frames 1006 in a data structure comprising a ring buffer 1066 and refine, using the ring buffer 1066, one or more equations of motion associated with the trajectory 1030, wherein the one or more equations of motion are based on the physical model of projectile motion 1032. In an embodiment, a data structure may include arrays, lists, queues, buffers, trees, hash tables, or combinations thereof, and the like. In a non-limiting example, the data structure may be configured to store image data 1012, timestamps, or trajectory 1030-related information in a manner that enables efficient retrieval and processing. Without limitation, the data structure may support dynamic updates, indexing, and memory 1004 management operations to facilitate real-time or post-processing tasks, and the like. In an embodiment, a ring buffer 1066 may include a contiguous memory 1004 allocation with a write pointer and a read pointer that wrap around upon reaching a boundary, and the like. In a non-limiting example, the ring buffer 1066 may continuously store incoming frames 1006 from an imaging device while discarding the oldest frames 1006 when new frames 1006 are added beyond capacity. Without limitation, the ring buffer 1066 may enable efficient memory 1004 usage and low-latency access to recent data for processing operations, and the like. The processor 1002 may store the plurality of frames 1006 in the ring buffer 1066 such that the most recent frames 1006 of the object 1008 in flight are continuously maintained in memory 1004 while older frames 1006 are overwritten as new frames 1006 are captured. In an embodiment, the ring buffer 1066 may allow the processor 1002 to access a sliding windowing of frames 1006 corresponding to a recent time interval of the object 1008's motion, enabling efficient processing without requiring storage of all captured frames 1006. In a non-limiting example, the processor 1002 may refine the one or more equations of motion by reprocessing frames 1006 stored in the ring buffer 1066 to extract additional position 1028 or distance information that may not have been fully processed in real-time. Continuing the previous non-limiting example, the processor 1002 may revisit earlier frames 1006 within the ring buffer 1066 to improve accuracy of detected positions, recompute distance estimates, or incorporate additional frames 1006 into curve fitting processes, thereby reducing noise and improving the fidelity of the trajectory 1030. Without limitation, the ring buffer 1066 may enable both real-time analysis and retrospective refinement by maintaining access to recent historical data while optimizing memory 1004 usage and computational efficiency. This configuration may provide a technical solution to challenges associated with limited memory 1004 resources, high data throughput, and real-time processing constraints in image-based motion analysis systems. In an embodiment, continuous capture of high-frame-rate image data 1012 may generate large volumes of data that could exceed available memory 1004 or processing capacity, and the use of the ring buffer 1066 may enable bounded memory 1004 utilization by storing only a most recent subset of frames 1006 while automatically discarding older frames 1006. In a non-limiting example, this approach may reduce memory 1004 overhead and may avoid system instability or latency associated with unbounded storage growth, thereby potentially improving performance of resource-constrained devices such as mobile processors or embedded systems. In another non-limiting example, the ring buffer 1066 may enable a hybrid processing model in which frames 1006 may be initially skipped or partially processed during real-time capture and may later be revisited for more computationally intensive analysis. Continuing the previous non-limiting example, the processor 1002 may refine equations of motion by reprocessing stored frames 1006 with more accurate algorithms, thereby potentially improving accuracy without interrupting real-time operation. Without limitation, this capability may address a technical limitation of conventional systems that may otherwise choose between real-time processing and high-accuracy processing, by enabling both through staged analysis. In an embodiment, the ring buffer 1066 may further enable temporal coherence and synchronization of data used in curve fitting and motion modeling, such that a consistent and contiguous sequence of frames 1006 may be available for computing equations of motion. In a non-limiting example, the processor 1002 may access a time-windowed sequence of frames 1006 from the ring buffer 1066 to perform fitting operations that may reduce noise and improve robustness of trajectory 1030 estimation. Without limitation, this structured data handling may improve computational efficiency, reduce latency, and enhance accuracy of motion reconstruction, thereby providing a technical improvement in computer vision system performance.

With continued reference to FIG. 1, the at least a computing device may include an edge computing device configured to compress the plurality of frames, store the plurality of frames, and analyze the plurality of frames locally at the edge computing device. As used in this disclosure, “edge computing device” is a computing device configured to perform data processing operations at or near a data source rather than at a centralized remote system. In an embodiment, an edge computing device may include a camera-integrated processor that compresses 30 video frames per second prior to transmitting selected frames to a remote server. In a non-limiting example, an edge computing device may include a gateway system that stores 1000 frames locally and performs real-time object detection before selectively transmitting metadata, alerts, and the like. Without limitation, an edge computing device may include a mobile device, embedded system, or industrial controller that analyzes sensor data streams locally to reduce latency, bandwidth usage, and the like. The at least a computing device may include an edge computing device configured to compress the plurality of frames, store the plurality of frames, and analyze the plurality of frames locally at the edge computing device. In an embodiment, the edge computing device may include at least 1 processor, memory, and storage configured to receive a continuous stream of frames from an image capture component, wherein the frames are parsed, normalized, and organized into a structured format for downstream processing. In a non-limiting example, the edge computing device may execute a compression pipeline that applies temporal compression, spatial compression, or hybrid compression techniques to reduce data size while preserving features relevant for subsequent analysis. Without limitation, the edge computing device may store compressed frames in a local data store and selectively retrieve subsets of frames for analysis based on triggers such as motion detection, anomaly detection, scheduling conditions, user-defined rules, and the like. In an embodiment, the edge computing device may include a machine learning model configured to analyze the plurality of frames to detect objects, classify events, or generate metadata associated with visual content. The machine learning model is the same as or substantially similar to the machine learning model described in FIGS. @@-$$. The training data may include historical message data, historical request logs, sensor data, user interaction data, and the like, enabling the model to learn patterns associated with objects, behaviors, or environmental conditions. In a non-limiting example, the model may include neural networks, gradient boosting models, support vector machines, and the like, which improve accuracy in identifying objects within frames, adapt to varying lighting or environmental conditions, and reduce manual intervention required for monitoring systems. Continuing the previous non-limiting example, the edge computing device may operate within a distributed computing environment that includes cloud-based systems, on-premises infrastructure, and networked edge nodes, wherein the edge computing device communicates via protocols such as HTTP, MQTT, or streaming protocols to transmit processed outputs, alerts, summaries, and the like. In an embodiment, the edge computing device may receive configuration updates, model updates, or control instructions via application programming interfaces, webhook triggers, or messaging queues, enabling dynamic adaptation of processing logic. Without limitation, the local analysis performed by the edge computing device may reduce latency, improve privacy by retaining sensitive data locally, optimize bandwidth utilization, and provide fault tolerance in scenarios where connectivity to centralized systems is intermittent or unavailable. Without limitation, processing is performed on a processor local to the imager such that image data generated by the imager is received directly by a processing component that is physically integrated with or directly coupled to the imager and is operated without reliance on a remote processing system. In an embodiment, the processor local to the imager may receive a continuous stream of raw frames and execute a multi-stage processing pipeline that includes pixel normalization, noise reduction, geometric correction, and compression prior to any external transmission. In a non-limiting example, the processor local to the imager may analyze 1 or more frames in real time to detect features, classify objects, or generate metadata, and may selectively transmit only derived outputs while retaining full-resolution frames in local storage. Without limitation, performing processing on the processor local to the imager may reduce latency, minimize bandwidth consumption, enhance data privacy by limiting external transmission of raw image data, and enable operation in environments with intermittent or constrained network connectivity. In an embodiment, the processor local to the imager may include a machine learning model configured to perform inference on image data to identify patterns, detect events, or classify visual content. The machine learning model is the same as or substantially similar to the machine learning model described in FIGS. @@-$$. The training data may include historical message data, historical request logs, sensor data, user interaction data, and the like, enabling adaptation to varying imaging conditions and operational environments. In a non-limiting example, the machine learning model may include neural networks, gradient boosting models, support vector machines, and the like, which provide increased accuracy in visual recognition tasks, adaptability to unstructured inputs, reduced manual intervention, and improved processing efficiency relative to conventional approaches. Continuing the previous non-limiting example, the processor local to the imager may interface with memory, storage subsystems, and network interfaces to buffer processed data, manage transmission scheduling, and communicate with external systems using protocols such as HTTP, streaming protocols, or messaging queues. In an embodiment, the processor local to the imager may receive configuration updates, model updates, or operational parameters via application programming interfaces, webhook triggers, or batch update mechanisms, enabling dynamic adjustment of processing behavior. Without limitation, the local execution of processing operations may support deployment across edge environments including mobile devices, surveillance systems, industrial monitoring platforms, autonomous systems, and the like, while improving responsiveness, reliability, and resource efficiency.

Still referring to FIG. 10, the at least a processor 1002 is configured to analyze the compressed plurality of frames by detecting, using a machine-learning model, the object in at least one frame of the compressed plurality of frames, wherein detection is performed at a second frame rate lower than or equal to the first frame rate. In an embodiment, the machine-learning model may be the same or similar to the machine-learning model as described in FIGS. 11-13. As used in this disclosure, “frame rate” is a frequency at which successive frames of image data are captured, processed, or displayed over a unit of time. In an embodiment, a frame rate may be expressed in frames per second representing a number of discrete image frames captured or analyzed within one second, and the like. In a non-limiting example, a frame rate may correspond to a capture rate of an imaging device, a processing rate of a machine-learning model, or a playback rate of a video stream, and the like. Without limitation, a frame rate may vary across system components such that capture, storage, processing, and display operations occur at different rates depending on computational constraints, resource availability, or system configuration, and the like. In an embodiment, the first frame rate may correspond to a capture frame rate at which the imaging device acquires frames, such that a high temporal resolution sequence of frames is stored in the memory buffer or ring buffer 1066, while the second frame rate corresponds to a detection frame rate at which the processor 1002 executes object detection operations using the machine-learning model 1014. In a non-limiting example, the processor 1002 may selectively sample frames from the compressed plurality of frames 1006 at intervals determined by the second frame rate, such that only a subset of frames is provided as input to the machine-learning model 1014 for object detection, thereby reducing computational load while maintaining sufficient temporal coverage to identify the object 1008. Continuing the previous non-limiting example, the processor 1002 may skip one or more intermediate frames between detection operations, wherein skipped frames remain stored in the ring buffer 1066 for later use in tracking, interpolation, or trajectory determination once the object 1008 has been detected. In another non-limiting example, the processor 1002 may dynamically adjust the second frame rate based on system conditions including processor utilization, thermal constraints, available memory bandwidth, or detection confidence, such that detection frequency is increased when computational resources are available and decreased when resources are constrained. Continuing the previous non-limiting example, detection may initially occur at a lower second frame rate to identify the presence of the object 1008 within the field of view, after which subsequent processing stages such as tracking may utilize a higher effective processing rate by leveraging additional frames stored in the ring buffer 1066. In an embodiment, the machine-learning model 1014 may process each selected frame independently to generate detection outputs including object location, confidence values, and associated features, wherein the processor 1002 aggregates detection results across multiple sampled frames to determine whether the object 1008 has been reliably detected. Without limitation, performing detection at a second frame rate lower than or equal to the first frame rate may reduce power consumption, avoid processor overload, and enable operation on resource-constrained devices while preserving high-fidelity motion information through storage of the full frame sequence for subsequent analysis. In an embodiment, the first frame rate may correspond to a capture frame rate at which the imaging device acquires frames, such as a high-frequency capture rate sufficient to preserve fine-grained motion of the object 1008, while the second frame rate corresponds to a reduced processing rate at which the processor 1002 performs detection using the machine-learning model 1014. In a non-limiting example, the processor 1002 may implement a performance optimization process in which not every captured frame is analyzed for detection, thereby reducing computational overhead and conserving system resources. Continuing the previous non-limiting example, the processor 1002 may sample frames from the compressed plurality of frames 1006 at an approximate rate of thirty frames per second while the imaging device captures frames at a higher rate such as sixty frames per second, thereby processing only a subset of available frames. Such selective sampling may enable reduced processor utilization, lower power consumption, and extended battery life while maintaining sufficient temporal resolution to reliably detect the object 1008. In another non-limiting example, the processor 1002 may skip intermediate frames between detection operations, wherein skipped frames remain stored in the ring buffer 1066 and are available for subsequent tracking, interpolation, or trajectory determination once detection has occurred. Continuing the previous non-limiting example, after the object 1008 is detected in one or more sampled frames, the processor 1002 may utilize additional frames that were not initially processed for detection to perform higher-resolution tracking and trajectory estimation. In an embodiment, the processor 1002 may dynamically adjust the second frame rate based on system conditions including processor load, thermal state, memory bandwidth, or detection confidence, such that detection frequency is increased or decreased in response to available resources. Without limitation, performing detection at a second frame rate lower than or equal to the first frame rate may enable efficient operation on mobile devices, embedded systems, or other resource-constrained platforms while preserving accuracy of downstream trajectory analysis through retention of the full set of captured frames for later use.

Still referring to FIG. 10, the at least a processor 1002 is further configured to analyze the compressed plurality of frames by selecting a subset of the compressed plurality of frames as a function of the detection of the at least one frame, wherein the subset of the compressed plurality of frames comprises a windowing of frames. In an embodiment, the at least one frame may include the object 1008. As used in this disclosure, “subset” is a selected portion of a larger set of data identified based on one or more selection criteria. In an embodiment, the selection criteria may include temporal proximity to a detected event, such that frames occurring within a defined time interval before and after detection of the object 1008 are selected. In a non-limiting example, the selection criteria may include detection confidence thresholds, wherein only frames associated with detection confidence values exceeding a threshold or within a confidence range are included in the subset. Without limitation, the selection criteria may include spatial relevance, motion continuity, frame quality metrics, classification outputs, or combinations thereof, and the like. In an embodiment, a subset may include a group of frames selected from a plurality of frames based on detection results, temporal proximity, confidence values, or relevance to an event of interest, and the like. In an embodiment, the processor may evaluate temporal criteria by identifying a detection frame and selecting frames within a predefined or adaptive time windowing relative to that frame, including pre-detection and post-detection frames stored in a ring buffer. In a non-limiting example, the processor may apply confidence-based criteria by weighting or filtering frames based on detection confidence, tracking confidence, or prediction certainty, thereby prioritizing frames that contribute reliable positional information. Continuing the previous non-limiting example, frames with low confidence or inconsistent detections may be excluded or down-weighted to reduce noise in subsequent trajectory calculations. In another non-limiting example, the processor may apply motion-based criteria by evaluating consistency of object 1008 position, velocity, or direction across frames, such that frames exhibiting discontinuities, occlusions, or implausible motion relative to the physical model are excluded from the subset. Continuing the previous non-limiting example, spatial criteria may include selecting frames in which the object 1008 lies within a region of interest or within expected bounds of motion, thereby excluding frames where the object 1008 is partially out of view or obscured. In an embodiment, the selection criteria may further include resource-based constraints, such as limiting the number of frames in the subset based on memory capacity, processing bandwidth, or latency requirements, while maintaining sufficient data for accurate trajectory estimation. Without limitation, the processor may dynamically adjust one or more selection criteria in response to system conditions, detection outcomes, or trajectory refinement needs, thereby ensuring that the selected subset remains both computationally efficient and analytically relevant. In a non-limiting example, a subset may be dynamically determined by a processor to include only those frames associated with detection of an object 1008 or frames surrounding the detection event in time. Without limitation, a subset may be contiguous or non-contiguous and may be defined using indexing, temporal thresholds, or logical conditions, and the like. As used in this disclosure, “windowing of frames” is a temporally bounded sequence of frames selected from a plurality of frames that corresponds to a defined time interval relative to an event. In an embodiment, a windowing of frames may include at least one pre-detection frame occurring prior to detection of an object 1008 and a plurality of post-detection frames occurring after detection, and the like. As used in this disclosure, “pre-detection frame” is a frame of image data captured prior to a frame in which an object 1008 is detected by a detection process. In an embodiment, a pre-detection frame may include image data in which the object 1008 is present but has not yet been identified by a machine-learning model, or may include frames immediately preceding the appearance of the object 1008 within a field of view, and the like. In a non-limiting example, a pre-detection frame may be retrieved from a ring buffer storing recently captured frames, thereby enabling analysis of object 1008 motion leading up to an initial detection event. Without limitation, a pre-detection frame may be used to establish initial conditions of motion including position, velocity, or context prior to confirmed detection, and the like. As used in this disclosure, “post-detection frame” is a frame of image data captured after a frame in which an object 1008 is detected by a detection process. In an embodiment, a post-detection frame may include image data in which the object 1008 continues to be present and is subject to tracking, analysis, or trajectory determination, and the like. In a non-limiting example, a post-detection frame may include successive frames following an initial detection event that capture ongoing motion of the object 1008 across time. Without limitation, a post-detection frame may be used to refine position estimates, compute motion parameters, or extend a trajectory model based on continued observation of the object 1008, and the like. In a non-limiting example, a windowing of frames may be centered around a detection event such that frames immediately preceding and following the detection are included to capture contextual motion of the object 1008. Without limitation, a windowing of frames may be defined using a fixed duration, a variable duration based on motion characteristics, or adaptive criteria derived from detection confidence or trajectory estimation, and the like. In an embodiment, the processor 1002 may continuously receive and store compressed frames within a ring buffer 1066 while operating a detection process at a reduced frame rate, such that a detection event corresponds to identification of the object 1008 within a particular frame indexed in time. In a non-limiting example, upon detection of the object 1008 in the at least one frame, the processor 1002 may determine a temporal anchor point associated with the detection event and may select frames surrounding that anchor point to construct the subset. Continuing the previous non-limiting example, the processor 1002 may access previously stored frames in the ring buffer 1066 to retrieve pre-detection frames that occurred prior to the detection event and may concurrently continue capturing and storing additional frames to include post-detection frames that follow the detection event, thereby forming a temporally contiguous windowing of frames. In another non-limiting example, the processor 1002 may define boundaries of the windowing of frames based on a predetermined duration, a number of frames, or adaptive criteria derived from motion characteristics of the object 1008, such that the windowing captures a sufficient portion of the object's motion for subsequent analysis. Continuing the previous non-limiting example, the processor 1002 may expand the windowing if the object 1008 remains in motion and within the field of view, or may truncate the windowing if the object 1008 exits the field of view, detection confidence decreases below a threshold, or motion analysis is complete. In an embodiment, the selection of the subset as a function of detection may include evaluating temporal proximity, detection confidence, motion continuity, and spatial relevance, such that only frames contributing meaningful information about the object's trajectory are included. In a non-limiting example, frames in which the object 1008 is occluded, poorly detected, or outside a region of interest may be excluded or deprioritized, while frames exhibiting consistent motion and high-confidence detections are retained within the windowing. In another non-limiting example, the processor 1002 may utilize indexing structures, timestamp associations, or pointer-based access within the ring buffer 1066 to efficiently retrieve and organize the selected subset without duplicating frame data, thereby reducing memory overhead and access latency. Continuing the previous non-limiting example, the subset comprising the windowing of frames may be passed to downstream processes including tracking, distance estimation, and trajectory computation, wherein the inclusion of both pre-detection and post-detection frames enables reconstruction of motion leading into and following the detection event. In an embodiment, the processor 1002 may further coordinate concurrent operations such that frame capture, compression, detection, and subset selection occur in overlapping execution cycles, thereby enabling near real-time identification and extraction of relevant frame sequences. Without limitation, this approach may improve computational efficiency by limiting intensive analysis to a focused subset of frames while preserving the full captured sequence for potential later use, thereby balancing resource utilization with analytical accuracy.

Still referring to FIG. 10, the at least a processor 1002 is further configured to analyze the compressed plurality of frames by determining one or more distances between the at least an imaging device and the object by computing an appearance of the object based on the windowing of frames. In an embodiment, the processor 1002 may aggregate image data corresponding to the object 1008 across the windowing of frames, wherein each frame provides a distinct observation of the object 1008 at a different time, position, orientation, or scale, thereby forming a multi-frame representation of the object's appearance 1018. In a non-limiting example, the processor 1002 may extract visual features from each frame within the windowing of frames, including apparent size, edge definition, texture resolution, color distribution, blur characteristics, and shape contours, and the like, and may combine or compare such features across frames to generate a more robust representation of the appearance 1018 than would be obtained from a single frame. Continuing the previous non-limiting example, variations in the appearance 1018 across frames, such as changes in apparent size due to motion toward or away from the imaging device, may be used to infer relative depth changes and improve estimation of the one or more distances 1016. In another non-limiting example, the processor 1002 may input image data from multiple frames within the windowing of frames into a machine-learning model 1014 configured to process temporal or sequential data, such that the model leverages inter-frame relationships to predict distance values. Continuing the previous non-limiting example, the machine-learning model 1014 may utilize learned correlations between multi-frame appearance patterns and known distances, thereby improving robustness to noise, occlusion, or variability in lighting conditions compared to single-frame estimation. In an embodiment, the processor 1002 may further compute temporal consistency metrics across the windowing of frames, such that distance estimates derived from individual frames are compared, smoothed, or fused to produce a consistent sequence of distance values over time. In a non-limiting example, the processor 1002 may apply filtering or averaging operations across the windowing of frames to reduce fluctuations in estimated distances caused by noise or detection variability. Continuing the previous non-limiting example, outlier distance estimates associated with low-confidence frames may be attenuated or excluded from the final determination of the one or more distances 1016. In another non-limiting example, the processor 1002 may align frames within the windowing of frames based on detected positions of the object 1008, such that the appearance 1018 is normalized across frames to account for translation, scaling, or rotation prior to distance estimation. Continuing the previous non-limiting example, such normalization may improve consistency of feature extraction and enhance accuracy of distance prediction. In an embodiment, the processor 1002 may utilize the windowing of frames to capture both pre-detection and post-detection observations of the object 1008, thereby enabling estimation of initial distance, changes in distance over time, and validation of distance predictions using motion continuity. Without limitation, determining the one or more distances 1016 based on the windowing of frames may improve accuracy, robustness, and stability of distance estimation by leveraging multiple temporally related observations rather than relying on a single frame.

Still referring to FIG. 10, the at least a processor 1002 may be further configured to analyze the compressed plurality of frames by identifying a region of interest in subsequent frames of the compressed plurality of frames based on a position of the at least one frame. As used in this disclosure, “region of interest” is a defined portion of image data corresponding to an area selected for focused analysis based on relevance to a target object or event. In an embodiment, a region of interest may include a bounded area within a frame that is expected to contain the object based on prior detections, motion predictions, or spatial constraints, and the like. In a non-limiting example, a region of interest may initially encompass a relatively large portion of a frame, such as approximately fifty percent of the frame area, to increase likelihood of detecting the object when its position is unknown. Without limitation, a region of interest may be dynamically reduced in size after detection, such that subsequent processing focuses on a smaller area surrounding the detected object, thereby improving efficiency and reducing computational load. As used in this disclosure, “subsequent frames” is one or more frames of image data captured after a reference frame in which an event or detection occurs. In an embodiment, subsequent frames may include frames temporally following a detection frame and stored in a memory buffer or ring buffer for continued analysis of object motion, and the like. In a non-limiting example, subsequent frames may represent later time instances in which the object continues to move through a scene and may be used for tracking, refinement, or trajectory determination. Without limitation, subsequent frames may be processed sequentially, selectively, or in parallel depending on system configuration and processing requirements, and the like. As used in this disclosure, “position” is a spatial location of an object within a defined coordinate system. In an embodiment, a position may correspond to two-dimensional pixel coordinates within an image frame, three-dimensional coordinates relative to an imaging device, or a transformed coordinate representation derived from image data, and the like. In a non-limiting example, a position may be determined as a centroid, bounding region center, keypoint, or feature-based location of the object within a frame. Without limitation, a position may vary across frames to represent motion and may be used to guide tracking, prediction, and region selection processes, and the like. In an embodiment, the processor 1002 may perform an initial detection process over a relatively large portion of each frame, including scanning approximately fifty percent of the frame area, to identify the object 1008 when its location is not yet known. In a non-limiting example, once the object 1008 is detected and its position is determined within a detection frame, the processor 1002 may define a reduced region of interest centered around that position and may limit subsequent analysis to that reduced region. Continuing the previous non-limiting example, the processor 1002 may propagate the region of interest across subsequent frames by projecting the position of the object 1008 forward in time using motion estimates, such that the region of interest follows the expected trajectory of the object 1008. In another non-limiting example, the processor 1002 may dynamically resize the region of interest based on velocity, uncertainty, or detection confidence, expanding the region when uncertainty increases and contracting the region when confidence is high. In an embodiment, restricting processing to the region of interest in subsequent frames may allow the processor 1002 to apply detection or tracking algorithms more efficiently by reducing the number of pixels analyzed per frame, thereby conserving computational resources and enabling higher effective processing rates. Without limitation, the transition from an initially large search region to a smaller focused region may improve detection reliability, reduce false positives, and support real-time operation on resource-constrained devices while maintaining accurate localization and tracking of the object 1008.

Still referring to FIG. 10, the at least a processor 1002 is further configured to analyze the compressed plurality of frames by determining a position of the object within the windowing of frames based on the appearance of the object. In an embodiment, the processor 1002 may determine the position 1028 in each frame by identifying visual features associated with the object 1008, including edges, contours, brightness contrast, texture patterns, and shape characteristics, and the like, and computing a representative location such as a centroid or bounding region center. In a non-limiting example, the processor 1002 may analyze the apparent shape and contrast of a baseball within each frame of the windowing of frames, identify a circular boundary corresponding to the baseball, and compute a center point of that boundary as the position 1028. Continuing the previous non-limiting example, variations in lighting or motion blur across frames may be compensated by weighting edge strength or using learned feature representations to maintain consistent localization of the baseball even when visual clarity changes. In another non-limiting example, the processor 1002 may input image data from each frame into a machine-learning model trained to detect object locations, wherein the model outputs coordinates corresponding to the most probable location of the object based on learned appearance features such as size, orientation, and texture. Continuing the previous non-limiting example, the processor 1002 may use bounding boxes generated by the model and compute a central coordinate within each bounding box to define the position 1028 across the windowing of frames. In an embodiment, the processor 1002 may refine the determined positions by comparing appearance consistency across adjacent frames, such that abrupt deviations inconsistent with expected motion are smoothed or corrected. In a non-limiting example, if the object appears elongated due to motion blur in one frame, the processor 1002 may adjust the estimated position by referencing neighboring frames in which the object appears more clearly defined. In another non-limiting example, the processor 1002 may determine position 1028 by combining multiple appearance cues, such as detecting a high-contrast region corresponding to the object, verifying size consistency with expected object dimensions, and confirming temporal continuity of motion across the windowing of frames. Continuing the previous non-limiting example, the processor 1002 may track the object across frames by associating similar appearance features over time, thereby ensuring that the same object is consistently localized even in the presence of background clutter or partial occlusion. In an embodiment, determining the position 1028 based on the appearance 1018 across the windowing of frames may improve robustness by leveraging multiple observations of the object, thereby reducing sensitivity to noise, occlusion, or transient visual artifacts. Without limitation, this approach may enable accurate and stable position estimation necessary for subsequent distance determination and trajectory computation.

Still referring to FIG. 10, the at least a processor 1002 is further configured to analyze the compressed plurality of frames by determining a trajectory of the object as a function of the one or more distances and the position of the object using a physical model of projectile motion. As used in this disclosure, “physical model of projectile motion” is a mathematical representation that describes motion of an object through space over time based on one or more physical forces acting on the object. In an embodiment, a physical model of projectile motion may include equations incorporating gravity, drag forces, lift forces, initial velocity, acceleration, and environmental effects, and the like. In a non-limiting example, the physical model of projectile motion may represent motion along one or more axes using parametric equations relating position to time based on kinematic principles. Without limitation, a physical model of projectile motion may approximate motion using constant or variable acceleration terms and may be adapted to account for aerodynamic behavior of objects such as sports balls, and the like. In an embodiment, the processor 1002 may combine distance measurements and positional data derived from the windowing of frames to reconstruct spatial coordinates of the object 1008 over time, wherein each coordinate corresponds to a timestamp associated with a frame. The processor 1002 may then fit these spatial coordinates to one or more equations of motion defined by the physical model, thereby estimating parameters including initial position, initial velocity, and acceleration components along one or more axes. In a non-limiting example, the processor 1002 may determine motion along a depth axis by fitting distance values over time to an equation of motion of the form position as a function of initial position, velocity, and acceleration, thereby estimating how the object 1008 moves toward or away from the imaging device. Continuing the previous non-limiting example, the processor 1002 may compute lateral motion components by combining pixel-based positions with distance values to determine real-world coordinates along horizontal and vertical axes, thereby reconstructing a three-dimensional trajectory. In another non-limiting example, the processor 1002 may incorporate aerodynamic effects into the physical model, such as drag reducing forward velocity or lift forces altering vertical or lateral motion, thereby refining the trajectory to more accurately reflect real-world behavior of the object 1008. Continuing the previous non-limiting example, the processor 1002 may iteratively adjust model parameters to minimize deviation between observed positions derived from the frames and predicted positions generated by the physical model. In an embodiment, the processor 1002 may further validate the determined trajectory by comparing predicted projectile behavior with observed motion across the plurality of frames 1006, ensuring consistency with expected physical constraints. Without limitation, using the physical model of projectile motion 1032 may improve robustness and accuracy of trajectory determination by smoothing noise in the measured data, enforcing physically plausible motion, and enabling estimation of motion characteristics even in frames where direct observation is limited or noisy.

Still referring to FIG. 10, the at least a processor 1002 may be further configured to analyze the compressed plurality of frames by validating the trajectory based on predicted projectile behavior. As used in this disclosure, “predicted projectile behavior” is an expected motion pattern of an object over time generated by a physical model based on one or more estimated motion parameters. In an embodiment, predicted projectile behavior may include expected positions, velocities, accelerations, and directional changes of the object as determined from equations of motion, and the like. In a non-limiting example, predicted projectile behavior may represent a trajectory path computed using initial conditions and physical forces such as gravity, drag, and lift, and the like. Without limitation, predicted projectile behavior may be continuously updated as new data is incorporated and may serve as a reference for evaluating consistency of observed motion, and the like. In an embodiment, the processor 1002 may generate predicted positions of the object 1008 at corresponding timestamps using the physical model of projectile motion 1032 and previously estimated parameters including initial velocity and acceleration components. The processor 1002 may then compare these predicted positions with observed positions derived from the plurality of frames 1006 to determine whether the trajectory 1030 is consistent with expected physical motion. In a non-limiting example, the processor 1002 may compute an error metric representing a deviation between predicted positions and observed positions across the windowing of frames, and may determine that the trajectory 1030 is valid if the error metric falls within a predefined threshold. Continuing the previous non-limiting example, if the deviation exceeds the threshold, the processor 1002 may identify inconsistencies such as tracking errors, detection noise, or outlier frames and may refine or reject portions of the trajectory accordingly. In another non-limiting example, the processor 1002 may validate the trajectory by verifying that derived motion characteristics conform to expected physical constraints, including monotonic changes in velocity along a drag-affected axis, approximately constant acceleration in a gravity-dominated axis, or smooth curvature consistent with aerodynamic lift effects. Continuing the previous non-limiting example, abrupt discontinuities or physically implausible accelerations may indicate erroneous data, prompting reprocessing or filtering of affected frames. In an embodiment, the processor 1002 may iteratively refine the trajectory by adjusting model parameters and recomputing predicted projectile behavior until alignment between predicted and observed motion is achieved within acceptable limits. Without limitation, validating the trajectory based on predicted projectile behavior 1050 may improve reliability of the system by ensuring that computed trajectories adhere to physically plausible motion patterns and by reducing the impact of noise, occlusion, or detection inaccuracies.

With continued reference to FIG. 10, the at least a processor 1002 may be further configured to determine, using a pose estimation model 1068, a subject position 1070 relative to the object 1008 and determine, based on the subject position 1070, at least one launch parameter 1072 of the object 1008. As used in this disclosure, “pose estimation model” is a computational model configured to determine positions of one or more parts of a subject's body from image data. In an embodiment, a pose estimation model 1068 may include a machine-learning model 1014 configured to detect keypoints corresponding to joints, limbs, or body segments, and the like. In a non-limiting example, the pose estimation model 1068 may output 1052 coordinates corresponding to a subject's hands, arms, torso, or legs within a frame. Without limitation, the pose estimation model 1068 may operate on image data 1012 to infer spatial relationships and movement of the subject over time, and the like. As used in this disclosure, “subject position” is a spatial location or configuration of a subject or one or more parts of the subject within a coordinate system. In an embodiment, a subject position 1070 may include positions of keypoints corresponding to body parts, a centroid of the subject, relative positioning between body segments, or combinations thereof, and the like. In a non-limiting example, the subject position 1070 may represent a location of a subject's hand at a moment of interaction with an object 1008. Without limitation, the subject position 1070 may be defined in pixel coordinates, three-dimensional coordinates 1044, or relative coordinates with respect to another object 1008 or reference frame, and the like. As used in this disclosure, “launch parameter” is a parameter describing initial conditions of motion of an object at a moment of release. In an embodiment, a launch parameter 1072 may include initial velocity, launch angle, release position 1028, spin rate, orientation, or combinations thereof, and the like. In a non-limiting example, the launch parameter 1072 may define how an object 1008 begins its trajectory 1030 immediately after being released by a subject. Without limitation, the launch parameter 1072 may be derived from image data 1012, trajectory data 1054, subject motion, or combinations thereof, and the like. The processor 1002 may determine the subject position 1070 by inputting image data 1012 into the pose estimation model 1068, wherein the pose estimation model 1068 identifies keypoints corresponding to the subject and outputs spatial coordinates representing positions of body parts across one or more frames 1006. In an embodiment, the processor 1002 may determine a relative position 1028 between the subject and the object 1008 by comparing coordinates of the object 1008 and one or more keypoints of the subject, such as a hand or limb associated with releasing the object 1008. In a non-limiting example, the processor 1002 may identify a frame in which the subject's hand is in closest proximity to the object 1008 and designate that moment as a release event. In another non-limiting example, the processor 1002 may determine the at least one launch parameter 1072 based on the subject position 1070 by analyzing motion of the subject's body leading up to and at the release event, including velocity of a hand, orientation of a limb, and position 1028 of the subject relative to the imaging device. Continuing the previous non-limiting example, the processor 1002 may estimate an initial velocity vector of the object 1008 based on motion of the subject's hand at release, or determine a launch angle based on orientation of the hand and trajectory 1030 of the object 1008 immediately after release. Without limitation, the processor 1002 may combine subject position 1070 information with trajectory data 1054 of the object 1008 to improve accuracy of launch parameter 1072 estimation and provide additional insight into how the object 1008 was launched. In a non-limiting example, the subject may be a baseball pitcher captured in a sequence of frames 1006, wherein the pose estimation model 1068 identifies keypoints corresponding to the pitcher's shoulder, elbow, wrist, and hand across the frames 1006. The processor 1002 may determine the subject position 1070 by tracking the coordinates of the pitcher's hand and identifying a frame in which the hand is in closest proximity to the baseball, thereby designating a release event. Continuing the previous non-limiting example, the processor 1002 may determine a launch parameter 1072 by analyzing motion of the pitcher's hand immediately prior to and at the release event, such as calculating a velocity of the hand based on displacement across frames 1006 and using that velocity to estimate an initial velocity of the baseball. In another non-limiting example, the processor 1002 may determine a launch angle by evaluating an orientation of the pitcher's forearm and hand at the release event and combining that orientation with initial trajectory data 1054 of the baseball to estimate an angle of launch relative to a coordinate system. Without limitation, the processor 1002 may further refine the launch parameter 1072 by correlating the subject position 1070 with subsequent motion of the baseball, thereby improving accuracy of the estimated initial conditions of the trajectory 1030. The pose estimation model 1068 may be trained using a dataset comprising image data 1012 of subjects annotated with ground truth keypoints corresponding to body parts, wherein each training sample includes pixel data 1022 and labeled positions of joints such as shoulders, elbows, wrists, hips, knees, and the like. In an embodiment, the training process may include inputting the image data 1012 into a neural network configured for pose estimation, generating predicted keypoint locations, comparing the predicted keypoints to the annotated ground truth keypoints using a loss function, and iteratively updating model parameters to reduce prediction error. In a non-limiting example, the dataset may include images and video sequences of athletes performing actions such as throwing, pitching, or swinging under varying conditions including different lighting environments, camera angles, motion speeds, backgrounds, and subject appearances, and the like, to improve generalization of the pose estimation model 1068. Continuing the previous non-limiting example, the pose estimation model 1068 may be trained using supervised learning techniques in which labeled keypoint data is used to guide learning, and may incorporate data augmentation techniques such as rotation, scaling, occlusion simulation, and noise injection to improve robustness. Without limitation, the pose estimation model 1068 may include a convolutional neural network 1026 or other deep learning architecture configured to learn spatial relationships between pixels and body structures, wherein early layers detect low-level features such as edges and textures and deeper layers infer higher-level structures such as limb configurations and joint relationships. In an embodiment, the trained pose estimation model 1068 may output 1052 probability maps, coordinate predictions, or confidence scores for each keypoint, enabling the processor 1002 to determine subject position 1070 across frames 1006 and use that information to derive launch parameters 1072 of the object 1008.

With continued reference to FIG. 10, the apparatus 1000 may include object 1008 motion estimation. As used in this disclosure, “object 1008 motion estimation” is the process of determining motion characteristics of an object 1008 over time based on image data 1012. In an embodiment, object 1008 motion estimation may include determining distances between an imaging device and the object 1008, determining positions of the object 1008 across frames, and generating a trajectory of the object 1008, and the like. In a non-limiting example, object 1008 motion estimation may include fitting observed data to a physical model of projectile motion to derive velocity and acceleration of the object 1008. Without limitation, object 1008 motion estimation may further include validating motion using confidence metrics or predicted projectile behavior, and the like.

Without limitation, the object 1008 motion estimation may be applied across a variety of domains including aerospace systems, robotic systems, sports analytics platforms, security monitoring systems, and the like, wherein the method may be utilized to analyze motion, track object 1008, generate trajectory data, or support decision-making processes in such applications. In an embodiment, within aerospace applications, the method may be used to monitor flight paths of airborne object 1008, estimate trajectories of projectiles or debris, or support navigation and guidance systems. In a non-limiting example, within robotics, the method may enable robotic systems to perceive and predict motion of object 1008 in an environment, thereby supporting tasks including manipulation, interception, collision avoidance, or autonomous navigation. In another non-limiting example, within sports analytics, the method may be used to measure performance characteristics of athletes by analyzing trajectories of sports object 1008, enabling feedback related to velocity, spin, accuracy, or technique. Continuing the previous non-limiting example, the method may support real-time coaching tools, performance tracking systems, or broadcast enhancements that visualize motion data. Without limitation, within security applications, the method may be used to detect, track, and analyze motion of object 1008 within a monitored environment, enabling threat detection, anomaly identification, or automated alert generation, thereby enhancing situational awareness and system responsiveness. The measured motion may be classified into named classes, wherein the classification may be performed based on analysis of the trajectory of the object 1008 as determined from image data 1012. As used in this disclosure, “classes” are categories representing distinct types of motion patterns. In an embodiment, the classes may correspond to motion types such as fastball, curveball, slider, changeup, linear motion, parabolic motion, anomalous motion, and the like. In a non-limiting example, the classes may be defined based on characteristic features of motion including velocity profiles, acceleration patterns, curvature of trajectory, direction changes, or combinations thereof, and the like. In an embodiment, the processor 1002 may classify the measured motion by extracting one or more features from trajectory data, including features derived from a physical model of projectile motion such as initial velocity, acceleration components, curvature, or deviation from expected motion, and the like, and comparing those features to known class definitions. In a non-limiting example, the processor 1002 may input the trajectory data into a classification model trained on labeled motion data, wherein the classification model outputs a class label corresponding to a closest matching motion pattern. Continuing the previous non-limiting example, the classification model may include a machine-learning model, a rule-based system using threshold values, or a hybrid approach combining learned and deterministic criteria, and the like. Without limitation, the classification into named classes may be performed in real-time as motion is being estimated or after trajectory generation and validation, and may be used to support downstream processes including performance analysis, feedback generation, anomaly detection, or automated system responses, thereby enabling interpretation and utilization of motion information in a structured and actionable manner.

With continued reference to FIG. 10, the apparatus 1000 is an improvement on existing technology for multiple reasons. In an embodiment, the apparatus 1000 may improve accuracy of trajectory 1030 determination by utilizing a single imaging device in combination with machine-learning models 1014 configured to infer depth and motion characteristics from appearance 1018-based features, thereby reducing reliance on multiple sensors or complex calibration procedures. In a non-limiting example, the apparatus 1000 may enable three-dimensional trajectory 1030 reconstruction from two-dimensional image data 1012, which may reduce system cost, complexity, and setup requirements compared to systems that rely on multiple cameras or radar-based sensing. In another non-limiting example, the apparatus 1000 may improve computational efficiency by employing a data structure comprising a ring buffer 1066 to manage high-frame-rate image data 1012, enabling selective processing and retrospective refinement of trajectory 1030 calculations without requiring storage of all captured frames 1006. Continuing the previous non-limiting example, this approach may allow real-time operation on resource-constrained devices while still enabling high-accuracy post-processing, thereby overcoming limitations of conventional systems that may be forced to tradeoff between speed and accuracy. In an embodiment, the apparatus 1000 may further improve robustness of motion estimation by integrating machine-learning-based detection, tracking, and distance estimation with physics-based modeling of projectile motion, such that noisy or incomplete measurements may be refined using physical constraints. In a non-limiting example, fitting observed data to a physical model of projectile motion 1032 may reduce sensitivity to measurement error and improve stability of trajectory 1030 outputs across varying environmental conditions.

Without limitation, the apparatus 1000 may enhance user interaction and feedback capabilities by generating multimodal outputs including visual displays, audio signals 1056, and data-driven analytics, enabling real-time feedback, post-event analysis, and integration with external systems. In a non-limiting example, the apparatus 1000 may support automated classification, training analytics, and remote processing workflows, thereby extending functionality beyond simple measurement and providing a comprehensive technical solution for motion analysis.

Referring now to FIG. 11, an exemplary embodiment of a machine-learning module 1100 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 1104 to generate an algorithm instantiated in hardware or software logic, data structures, and/or functions that will be performed by a computing device/module to produce outputs 1108 given data provided as inputs 1112; this is in contrast to a non-machine learning software program where the commands to be executed are determined in advance by a user and written in a programming language.

Still referring to FIG. 11, “training data,” as used herein, is data containing correlations that a machine-learning process may use to model relationships between two or more categories of data elements. For instance, and without limitation, training data 1104 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 1104 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 1104 according to various correlations; correlations may indicate causative and/or predictive links between categories of data elements, which may be modeled as relationships such as mathematical relationships by machine-learning processes as described in further detail below. Training data 1104 may be formatted and/or organized by categories of data elements, for instance by associating data elements with one or more descriptors corresponding to categories of data elements. As a non-limiting example, training data 1104 may include data entered in standardized forms by persons or processes, such that entry of a given data element in a given field in a form may be mapped to one or more descriptors of categories. Elements in training data 1104 may be linked to descriptors of categories by tags, tokens, or other data elements; for instance, and without limitation, training data 1104 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 11, training data 1104 may include one or more elements that are not categorized; that is, training data 1104 may not be formatted or contain descriptors for some elements of data. Machine-learning algorithms and/or other processes may sort training data 1104 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 1104 to be made applicable for two or more distinct machine-learning algorithms as described in further detail below. Training data 1104 used by machine-learning module 1100 may correlate any input data as described in this disclosure to any output data as described in this disclosure. As a non-limiting illustrative example, input data may include pixel data from a plurality of frames capturing an object in flight along with corresponding timestamps, and the output data may include one or more distances between an imaging device and the object, two-dimensional pixel coordinates of the object, or three-dimensional position values representing the object's trajectory, and the like. In another non-limiting example, input data may include image data depicting an object under varying conditions such as different lighting, orientations, distances, and motion states, and the output data may include labeled ground truth distances, object positions, or trajectory parameters associated with the object, and the like. Continuing the previous non-limiting example, input data may further include sequences of frames representing motion of an object over time, and the output data may include derived motion characteristics such as velocity, acceleration, trajectory classification, or predicted projectile behavior, and the like. Without limitation, input data may also include image data of a subject interacting with the object, including pose-related features, and the output data may include subject positions, keypoint locations, or launch parameters associated with release of the object, and the like, thereby enabling the machine-learning module to learn relationships between visual inputs and both object-centric and subject-centric outputs.

Further referring to FIG. 11, training data may be filtered, sorted, and/or selected using one or more supervised and/or unsupervised machine-learning processes and/or models as described in further detail below; such models may include without limitation a training data classifier 1116. Training data classifier 1116 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 1100 may generate a classifier using a classification algorithm, defined as a processes whereby a computing device and/or any module and/or component operating thereon derives a classifier from training data 1104. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 1116 may classify elements of training data to categories corresponding to object types, motion patterns, environmental conditions, or user-specific performance profiles, and the like.

Still referring to FIG. 11, computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device may then calculate a likelihood table by calculating probabilities of different data entries and classification labels. Computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 11, computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 11, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 11, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 11, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 11, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 11, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 11, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than or equal to a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 11, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 11, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 11, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset

$${X}_{max} : {X}_{n e w} = \frac{X - {X}_{min}}{{X}_{{max}^{- {X}_{min}}}} .$$

Feature scaling may include mean normalization, which involves use of a mean value of a set and/or subset of values, Xₘₑₐₙ with maximum and minimum values:

$${X}_{n e w} = \frac{X - {X}_{m e a n}}{{X}_{max} - {X}_{min}} .$$

Feature scaling may include standardization, where a difference between X and Xₘₑₐₙ is divided by a standard deviation σ of a set or subset of values:

$${X}_{n e w} = \frac{X - {X}_{m e a n}}{σ} .$$

Scaling may be performed using a median value of a set or subset X_{medium} and/or interquartile range (IQR), which represents the difference between the 25^{th} percentile value and the 50^{th} percentile value (or closest values thereto by a rounding protocol), such as:

$${X}_{n e w} = \frac{X - {X}_{m e d i a n}}{IQR} .$$

Persons skilled in the art, upon reviewing the entirety of this disclosure, will be aware of various alternative or additional approaches that may be used for feature scaling.

Still referring to FIG. 11, machine-learning module 1100 may be configured to perform a lazy-learning process 1120 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 1104. Heuristic may include selecting some number of highest-ranking associations and/or training data 1104 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 11, machine-learning processes as described in this disclosure may be used to generate machine-learning models 1124. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 1124 may be generated by creating an artificial neural network, such as a convolutional neural network comprising an input layer of nodes, one or more intermediate layers, and an output layer of nodes. Connections between nodes may be created via the process of “training” the network, in which elements from a training data 1104 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 11, machine-learning algorithms may include at least a supervised machine-learning process 1128. At least a supervised machine-learning process 1128, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include pixel data from a plurality of frames capturing an object in flight as inputs, and corresponding labeled distances, object positions, or trajectory parameters as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 1104. Persons skilled in the art, upon reviewing the entirety of this disclosure, will be aware of various possible variations of at least a supervised machine-learning process 1128 that may be used to determine relation between inputs and outputs. Supervised machine-learning processes may include classification algorithms as defined above.

With further reference to FIG. 11, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 11, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 11, machine learning processes may include at least an unsupervised machine-learning processes 1132. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 1132 may not require a response variable; unsupervised processes 1132 may be used to find interesting patterns and/or inferences between variables, to determine a degree of correlation between two or more variables, or the like.

Still referring to FIG. 11, machine-learning module 1100 may be designed and configured to create a machine-learning model 1124 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 11, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 11, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 11, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 11, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 11, one or more processes or algorithms described above may be performed by at least a dedicated hardware unit 1136. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 1136 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 1136 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 1136 to perform one or more operations described herein, such as evaluation of model and/or algorithm outputs, one-time or iterative updates to parameters, coefficients, weights, and/or biases, and/or any other operations such as vector and/or matrix operations as described in this disclosure.

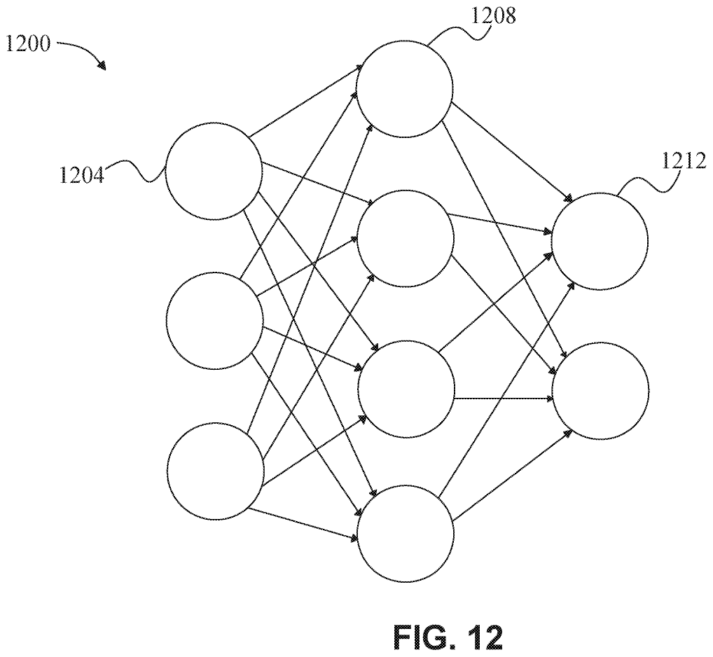

Referring now to FIG. 12, an exemplary embodiment of neural network 1200 is illustrated. A neural network 1200 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 1204, one or more intermediate layers 1208, and an output layer of nodes 1212. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

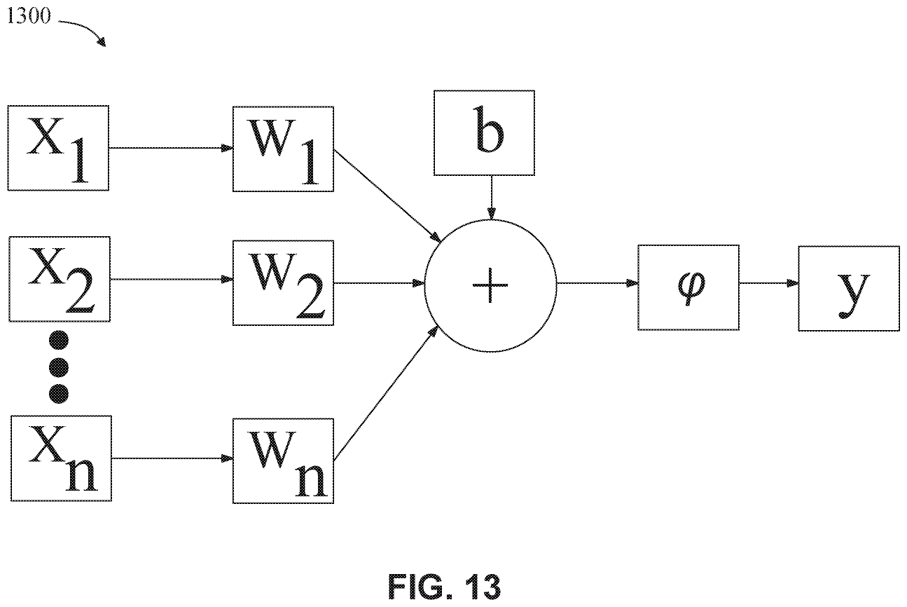

Referring now to FIG. 13, an exemplary embodiment of a node 1300 of a neural network is illustrated. A node may include, without limitation, a plurality of inputs xi that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as ƒ(x)=tanh²(x), a rectified linear unit function such as ƒ(x)=max(0,x), a “leaky” and/or “parametric” rectified linear unit function such as ƒ(x)=max(ax,x) for some a, an exponential linear units function such as

$$f ( x ) = λ \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as ƒ(x)=x*sigmoid(x), a Gaussian error linear unit function such as ƒ(x)=a(1+tanh(\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights w; that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

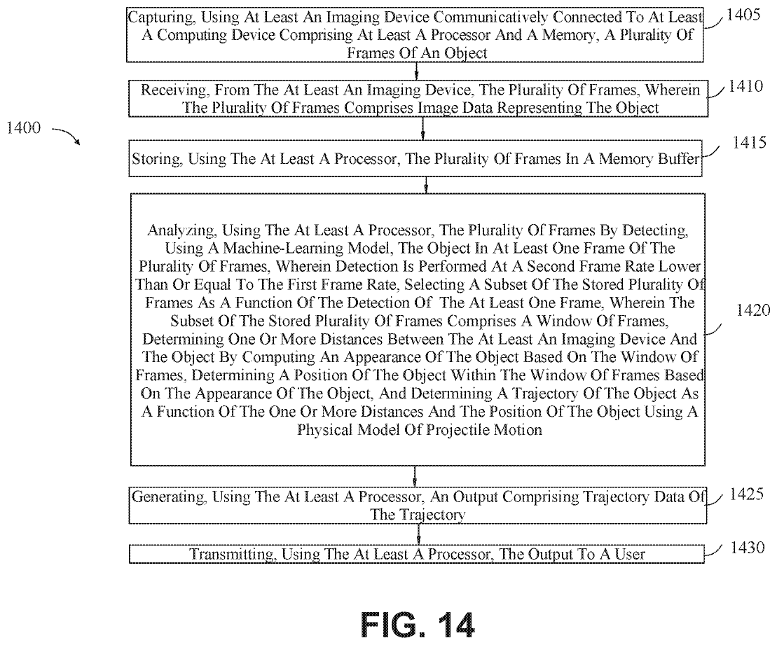

Referring now to FIG. 14, a flow diagram of an exemplary method 1400 for measuring a trajectory of an object is illustrated. At step 1405, method 1400 includes capturing, using at least an imaging device communicatively connected to at least a computing device comprising at least a processor and a memory, a plurality of frames of an object in flight. In an embodiment, the at least an imaging device may include a monocular camera. This may be implemented as described and with reference to FIGS. 1-13.

Still referring to FIG. 14, at step 1410, method 1400 includes receiving, from the at least an imaging device, the plurality of frames, wherein the plurality of frames comprises image data representing the object in flight. This may be implemented as described and with reference to FIGS. 1-13.

Still referring to FIG. 14, at step 1415, method 1400 includes storing, using the at least a processor, the plurality of frames in a memory buffer. In an embodiment, the method may further include storing, using the memory, the plurality of frames in a data structure comprising a ring buffer and refining, using the ring buffer, one or more equations of motion associated with the trajectory, wherein the one or more equations of motion are based on the physical model of projectile motion. In an embodiment, the method may further include compressing, using an edge computing device of the at least a computing device, the plurality of frames, storing, using the edge computing device, the plurality of frames, and analyzing, using the edge computing device, the plurality of frames locally at the edge computing device. This may be implemented as described and with reference to FIGS. 1-13.

Still referring to FIG. 14, at step 1420, method 1400 includes analyzing, using the at least a processor, the plurality of frames by detecting, using a machine-learning model, the object in at least one frame of the plurality of frames, wherein detection is performed at a second frame rate lower than or equal to the first frame rate, selecting a subset of the plurality of frames as a function of the detection of the at least one frame, wherein the subset of the plurality of frames comprises a windowing of frames, determining one or more distances between the at least an imaging device and the object by computing an appearance of the object based on the windowing of frames, identifying a region of interest in subsequent frames of the plurality of frames based on a position of the at least one frame, determining a position of the object within the windowing of frames based on the appearance of the object, and determining a trajectory of the object as a function of the one or more distances and the position of the object using a physical model of projectile motion. In an embodiment, the method may further include selecting the subset of the stored plurality of frames as a function of the detection of the object in the at least one frame. In an embodiment, the method may further include calculating, using the one or more distances and corresponding timestamps of the plurality of frames, an axial equation of motion by fitting the one or more distances to the physical model of projectile motion along an axial direction, determining, using the machine-learning model, two-dimensional pixel coordinates of the object in at least three frames of the plurality of frames, and calculating, using the at least a processor, three-dimensional coordinates of the object relative to the at least an imaging device by combining the two-dimensional pixel coordinates with at least one of the one or more distances or the axial equation of motion. In an embodiment, the method may further include generating, using the at least a processor, the trajectory by fitting the three-dimensional coordinates over time to the physical model of projectile motion. This may be implemented as described and with reference to FIGS. 1-13.

Still referring to FIG. 14, at step 1425, method 1400 includes generating, using the at least a processor, an output comprising trajectory data of the trajectory. In an embodiment, the method may further include generating, using the at least a processor, a video playback of the plurality of frames and displaying, using a user interface, the video playback of the plurality of frames. In an embodiment, the method may further include generating audio signals of the output and wherein generating the audio signals may include mapping, using the at least a processor, one or more characteristics of the object to corresponding audio signals and generating, using the at least a processor, the corresponding audio signals for output. In an embodiment, the method may further include calculating, using the at least a processor, a confidence metric associated with the trajectory and determining, using the at least a processor, an acceptance datum of the trajectory based on the confidence metric. This may be implemented as described and with reference to FIGS. 1-13

Still referring to FIG. 14, at step 1430, method 1400 includes transmitting, using the at least a processor, the output to a user. In an embodiment, the method may further include determining, using a pose estimation model, a subject position relative to the object and determining, based on the subject position, at least one launch parameter of the object. This may be implemented as described and with reference to FIGS. 1-13.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

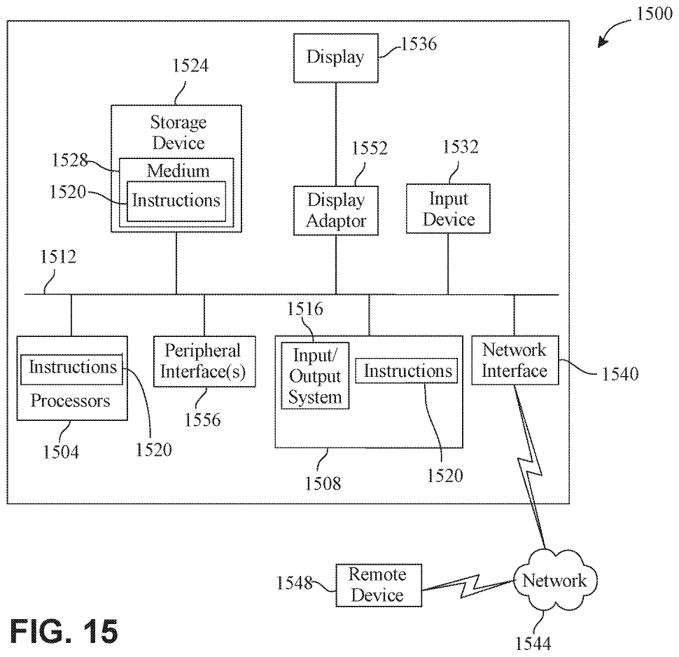

FIG. 15 shows a diagrammatic representation of one embodiment of a computing device in the exemplary form of a computer system 1500 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1500 includes a processor 1504 and a memory 1508 that communicate with each other, and with other components, via a bus 1512. Bus 1512 may include any of several types of bus structures including, but not limited to, a memory bus, a memory controller, a peripheral bus, a local bus, and any combinations thereof, using any of a variety of bus architectures.

Processor 1504 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1504 may be organized according to Von Neumann and/or Harvard architecture as a non-limiting example. Processor 1504 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo's algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 1508 may include various components (e.g., machine-readable media) including, but not limited to, a random-access memory component, a read only component, and any combinations thereof. In one example, a basic input/output system 1516 (BIOS), including basic routines that help to transfer information between elements within computer system 1500, such as during start-up, may be stored in memory 1508. Memory 1508 may also include (e.g., stored on one or more machine-readable media) instructions (e.g., software) 1520 embodying any one or more of the aspects and/or methodologies of the present disclosure. In another example, memory 1508 may further include any number of program modules including, but not limited to, an operating system, one or more application programs, other program modules, program data, and any combinations thereof. Memory 1508 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 1500 may also include a storage device 1524. Examples of a storage device (e.g., storage device 1524) include, but are not limited to, a hard disk drive, a magnetic disk drive, an optical disc drive in combination with an optical medium, a solid-state memory device, and any combinations thereof. Storage device 1524 may be connected to bus 1512 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1524 (or one or more components thereof) may be removably interfaced with computer system 1500 (e.g., via an external port connector (not shown)). Particularly, storage device 1524 and an associated machine-readable medium 1528 may provide nonvolatile and/or volatile storage of machine-readable instructions, data structures, program modules, and/or other data for computer system 1500. In some embodiments, storage device 1524 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software 1520 may reside, completely or partially, within machine-readable medium 1528. In another example, software 1520 may reside, completely or partially, within processor 1504.

Computer system 1500 may also include an input device 1532. In one example, a user of computer system 1500 may enter commands and/or other information into computer system 1500 via input device 1532. Examples of an input device 1532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1532 may be interfaced to bus 1512 via any of a variety of interfaces (not shown) including, but not limited to, a serial interface, a parallel interface, a game port, a USB interface, a FIREWIRE interface, a direct interface to bus 1512, and any combinations thereof. Input device 1532 may include a touch screen interface that may be a part of or separate from display 1536, discussed further below. Input device 1532 may be utilized as a user selection device for selecting one or more graphical representations in a graphical interface as described above.

A user may also input commands and/or other information to computer system 1500 via storage device 1524 (e.g., a removable disk drive, a flash drive, etc.) and/or network interface device 1540. A network interface device, such as network interface device 1540, may be utilized for connecting computer system 1500 to one or more of a variety of networks, such as network 1544, and one or more remote devices 1548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1544, may employ a wired and/or a wireless mode of communication. In general, any network topology may be used. Information (e.g., data, software 1520, etc.) may be communicated to and/or from computer system 1500 via network interface device 1540.

Computer system 1500 may further include a video display adapter 1552 for communicating a displayable image to a display device, such as display 1536. Examples of a display device include, but are not limited to, a liquid crystal display (LCD), a cathode ray tube (CRT), a plasma display, a light emitting diode (LED) display, and any combinations thereof. Display adapter 1552 and display 1536 may be utilized in combination with processor 1504 to provide graphical representations of aspects of the present disclosure. In addition to a display device, computer system 1500 may include one or more other peripheral output devices including, but not limited to, an audio speaker, a printer, and any combinations thereof. Such peripheral output devices may be connected to bus 1512 via a peripheral interface 1556. Examples of a peripheral interface include, but are not limited to, a serial port, a USB connection, a FIREWIRE connection, a parallel connection, and any combinations thereof.

Further referring to FIG. 15, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 15, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 15, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windowings, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 1500, processor 1504, and memory 1508 may be virtualized; that is, a virtual machine and/or container may interact directly with such computing system 1500, processor 1504, and/or memory 1508, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 1504 comprises a plurality of processors and/or processor cores, virtualization may, in some cases, simulate or emulate a single (virtual) processor whose functions are allocated to one or more of the plurality of processors and/or processor cores. In this case, while processor 1504 may be said to be virtualized, the processor 1504, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An apparatus for measuring a trajectory of an object, wherein the apparatus comprises:
at least an imaging device configured to capture a plurality of frames of an object at a first frame rate; and
at least a computing device, wherein the at least a computing device comprises:
a memory; and
at least a processor communicatively connected to the memory, wherein the memory contains instructions configuring the at least a processor to:
receive, from the at least an imaging device, the plurality of frames, wherein the plurality of frames comprises image data representing the object;
store the plurality of frames in a memory buffer;
analyze the plurality of frames by:
detecting, using a machine-learning model, the object in at least one frame of the plurality of frames, wherein detection is performed at a second frame rate lower than or equal to the first frame rate;
selecting a subset of the stored plurality of frames as a function of the detection of the at least one frame, wherein the subset of the stored plurality of frames comprises a windowing of frames;
determining one or more distances between the at least an imaging device and the object by computing an appearance of the object based on the windowing of frames;
determining a position of the object within the windowing of frames based on the appearance of the object; and
determining a trajectory of the object as a function of the one or more distances and the position of the object using a physical model of projectile motion;
generate an output comprising trajectory data of the trajectory; and
transmit the output to a user.

2. The apparatus of claim 1, wherein the at least an imaging device comprises a monocular camera.

3. The apparatus of claim 1, wherein the at least a computing device comprises an edge computing device configured to:
compress, using a compression process, the plurality of frames;
store the compressed plurality of frames; and
analyze the compressed plurality of frames locally at the edge computing device.

4. The apparatus of claim 1, wherein the at least a processor is further configured to:
generate the output comprising a video playback of the plurality of frames; and
display, using a user interface, the video playback of the plurality of frames, wherein the video playback comprises at least an overlay of one or more trajectory metrics corresponding to the trajectory and a tracer corresponding to the trajectory.

5. The apparatus in claim 1, wherein the output further comprises audio signals and wherein the at least a processor is further configured to:
map one or more characteristics of the object to corresponding audio signals; and
generate the corresponding audio signals for output.

6. The apparatus of claim 1, wherein the at least a processor is further configured to:
calculate, using the one or more distances and corresponding timestamps of the plurality of frames, an axial equation of motion by fitting the one or more distances to the physical model of projectile motion along an axial direction;
determine, using the machine-learning model, two-dimensional pixel coordinates of the object in at least three frames of the plurality of frames; and
calculate three-dimensional coordinates of the object relative to the at least an imaging device by combining the two-dimensional pixel coordinates with at least one of the one or more distances or the axial equation of motion.

7. The apparatus of claim 6, wherein the at least a processor is further configured to generate the trajectory by fitting the three-dimensional coordinates over time to the physical model of projectile motion.

8. The apparatus of claim 1, wherein storing, using the memory buffer, the plurality of frames comprises:
storing the plurality of frames in a ring buffer; and
refining, using the ring buffer, one or more equations of motion associated with the trajectory, wherein the one or more equations of motion are based on the physical model of projectile motion.

9. The apparatus of claim 1, wherein the at least a processor is further configured to validate the trajectory based on predicted projectile behavior.

10. The apparatus in claim 1, wherein the at least a processor is further configured to:
determine, using a pose estimation model, a subject position relative to the object; and
determine, based on the subject position, at least one launch parameter of the object.

11. The apparatus in claim 1, wherein the at least a processor is further configured to select the subset of the stored plurality of frames as a function of the detection of the object in the at least one frame.

12. The apparatus of claim 1, wherein the at least a processor is further configured to identify a region of interest in subsequent frames of the plurality of frames based on a position of the object in the at least one frame.

13. A method of measuring a trajectory of an object, wherein the method comprises:
capturing, using at least an imaging device communicatively connected to at least a computing device comprising at least a processor and a memory, a plurality of frames of an object at a first frame rate;
receiving, from the at least an imaging device, the plurality of frames, wherein the plurality of frames comprises image data representing the object;
storing, using the at least a processor, the plurality of frames in a memory buffer;
analyzing, using the at least a processor, the plurality of frames by:
detecting, using a machine-learning model, the object in at least one frame of the plurality of frames, wherein detection is performed at a second frame rate lower than or equal to the first frame rate;
selecting a subset of the stored plurality of frames as a function of the detection of the at least one frame, wherein the subset of the stored plurality of frames comprises a windowing of frames;
determining one or more distances between the at least an imaging device and the object by computing an appearance of the object based on the windowing of frames;
determining a position of the object within the windowing of frames based on the appearance of the object; and
determining a trajectory of the object as a function of the one or more distances and the position of the object using a physical model of projectile motion;
generating, using the at least a processor, an output comprising trajectory data of the trajectory; and
transmitting, using the at least a processor, the output to a user.

14. The method of claim 13, wherein the at least an imaging device comprises a monocular camera.

15. The method of claim 13, further comprising:
compressing, using an edge computing device of the at least a computing device and a compression process, the plurality of frames;
storing, using the edge computing device, the compressed plurality of frames; and
analyzing, using the edge computing device, the compressed plurality of frames locally at the edge computing device.

16. The method of claim 13, further comprising:
generating, using the at least a processor, a video playback of the plurality of frames; and
displaying, using a user interface, the video playback of the plurality of frames.

17. The method in claim 13, wherein the output further comprises audio signals and wherein the method further comprises:
mapping, using the at least a processor, one or more characteristics of the object to corresponding audio signals; and
generating, using the at least a processor, the corresponding audio signals for output.

18. The method of claim 13, further comprising:
calculating, using the one or more distances and corresponding timestamps of the plurality of frames, an axial equation of motion by fitting the one or more distances to the physical model of projectile motion along an axial direction;
determining, using the machine-learning model, two-dimensional pixel coordinates of the object in at least three frames of the plurality of frames; and
calculating, using the at least a processor, three-dimensional coordinates of the object relative to the at least an imaging device by combining the two-dimensional pixel coordinates with at least one of the one or more distances or the axial equation of motion.

19. The method of claim 18, further comprising generating, using the at least a processor, the trajectory by fitting the three-dimensional coordinates over time to the physical model of projectile motion.

20. The method of claim 13, further comprising:
storing, using the memory, the plurality of frames in a data structure comprising a ring buffer; and
refining, using the ring buffer, one or more equations of motion associated with the trajectory, wherein the one or more equations of motion are based on the physical model of projectile motion.

21. The method of claim 13, further comprising validating, using the at least a processor, the trajectory based on predicted projectile behavior.

22. The method in claim 13, further comprising:
determining, using a pose estimation model, a subject position relative to the object; and
determining, based on the subject position, at least one launch parameter of the object.

23. The method in claim 13, further comprising selecting the subset of the stored plurality of frames as a function of the detection of the object in the at least one frame.

24. The method of claim 13, further comprising identifying a region of interest in subsequent frames of the plurality of frames based on a position of the object in the at least one frame.
